(19) United States
(12) Patent Application Publication
(10) Pub. No.: US 2025/0365812 A1
(43) Pub. Date: Nov. 27, 2025

(54) SYSTEMS AND METHODS FOR DYNAMIC REASSEMBLY TIMER

(71) Applicant: QUALCOMM Incorporated, San Diego, CA (US)

(72) Inventors: Sherif Elazzouni, San Diego, CA (US); Gavin Bernard Horn, La Jolla, CA (US); Ozcan Ozturk, San Diego, CA (US); Xing Chen, San Diego, CA (US)

(21) Appl. No.: 18/674,309

(22) Filed: May 24, 2024

(51) Int. Cl. H04W 76/38

(52) U.S. Cl. CPC H04W 76/38

(57) ABSTRACT

In one aspect, a device for wireless communication is disclosed. The device includes at least one processor and a memory coupled to the at least one processor. The at least one processor is configured to cause the device to: receive reassembly timer configuration information. The at least one processor is also configured to receive one or more radio link control (RLC) segments, each RLC segment associated with a sequence number (SN), wherein the one or more RLC segments are associated with a reassembly timer expiration time based on the reassembly timer configuration information. The at least one processor is further configured to: release, prior to the reassembly timer expiration time, the one or more RLC segments based on an adjusted reassembly timer expiration time. The adjusted reassembly timer expiration time is determined based on an output from a learning model of the device. Other aspects are described and claimed.

### BACKGROUND

### Field

Aspects of the present disclosure relate generally to wireless communication systems, and more particularly, to reassembly timer operations. Certain embodiments of the technology discussed below can enable and provide enhanced reassembly timer operations, including dynamic reassembly timer adjustments to reduce bandwidth usage and latency.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a device for wireless communication is disclosed. The device includes at least one processor and a memory coupled to the at least one processor. The at least one processor is configured to cause the device to: receive reassembly timer configuration information. The at least one processor is also configured to receive one or more radio link control (RLC) segments, each RLC segment associated with a sequence number (SN), wherein the one or more RLC segments are associated with a reassembly timer expiration time based on the reassembly timer configuration information. The at least one processor is further configured to: release, prior to the reassembly timer expiration time, the one or more RLC segments based on an adjusted reassembly timer expiration time. The adjusted reassembly timer expiration time is determined based on an output from a learning model of the device.

In another aspect of the disclosure, a method of wireless communication includes receive reassembly timer configuration information; receive one or more radio link control (RLC) segments, each RLC segment associated with a sequence number (SN), wherein the one or more RLC segments are associated with a reassembly timer expiration time based on the reassembly timer configuration information; and release, prior to the reassembly timer expiration time, the one or more RLC segments based on an adjusted reassembly timer expiration time, the adjusted reassembly timer expiration time determined based on an output from a learning model of the device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3 is a diagram of an example of reassembly timer operations according to some aspects of the present disclosure.

FIG. 4 is a block diagram illustrating an example of a wireless communications system for dynamic reassembly timer operations according to some aspects of the present disclosure.

FIG. 5 is a ladder diagram of an example of dynamic reassembly timer operations according to some aspects of the present disclosure.

FIG. 6 is a ladder diagram of another example of dynamic reassembly timer operations according to some embodiments of the present disclosure.

FIG. 7 is a ladder diagram of another example of dynamic reassembly timer operations according to some embodiments of the present disclosure.

FIG. 8 is a diagram of an example of a reassembly timer update indication format for dynamic reassembly timer operations according to some embodiments of the present disclosure.

FIG. 9 is a diagram of an example of reassembly timer configuration information for dynamic reassembly timer operations according to some embodiments of the present disclosure.

FIG. 10 is a flow diagram illustrating example blocks executed by a UE configured according to an aspect of the present disclosure.

FIG. 11 is a flow diagram illustrating example blocks executed by a network device configured according to an aspect of the present disclosure.

FIG. 12 is a block diagram conceptually illustrating a design of a UE configured to perform dynamic reassembly timer operations according to some embodiments of the present disclosure.

FIG. 13 is a block diagram conceptually illustrating a design of a network device configured to perform dynamic reassembly timer operations according to some embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

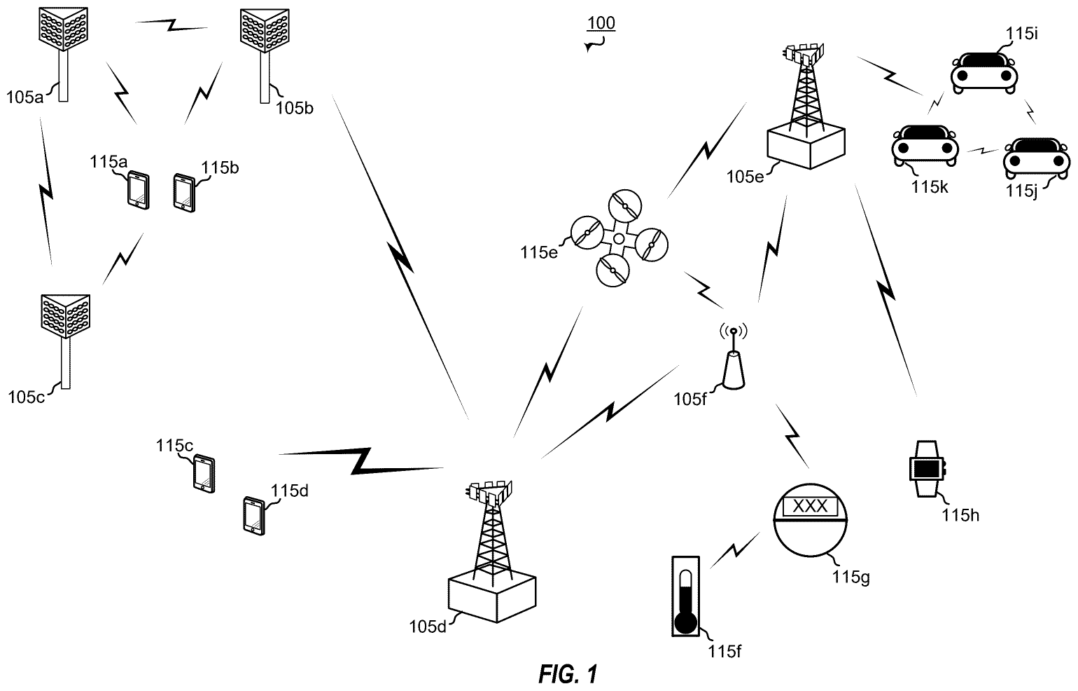

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE may be a device that includes a Universal Integrated Circuit Card (UICC). In another aspect, a UE may be a device that does not include a UICC. In some aspects, UEs that do not include UICCs may also be referred to as internet of everything (IoE) or internet of things (IoT) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations.

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

5G network 100 also support mission critical communications with ultra-reliable and redundant links for mission critical devices, such UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

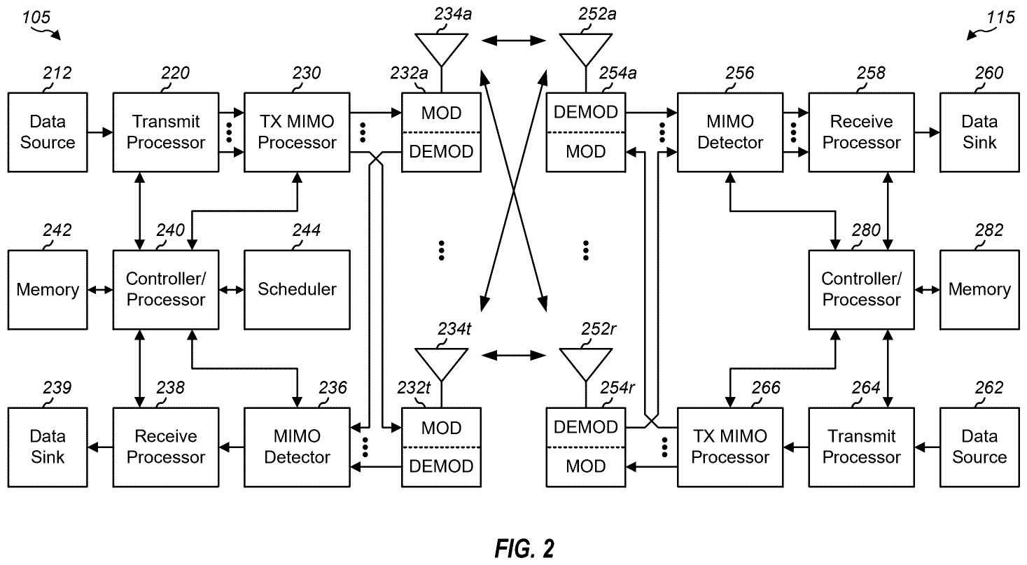

FIG. 2 shows a block diagram of a design of a base station 105 and a UE 115, which may be one of the base station and one of the UEs in FIG. 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

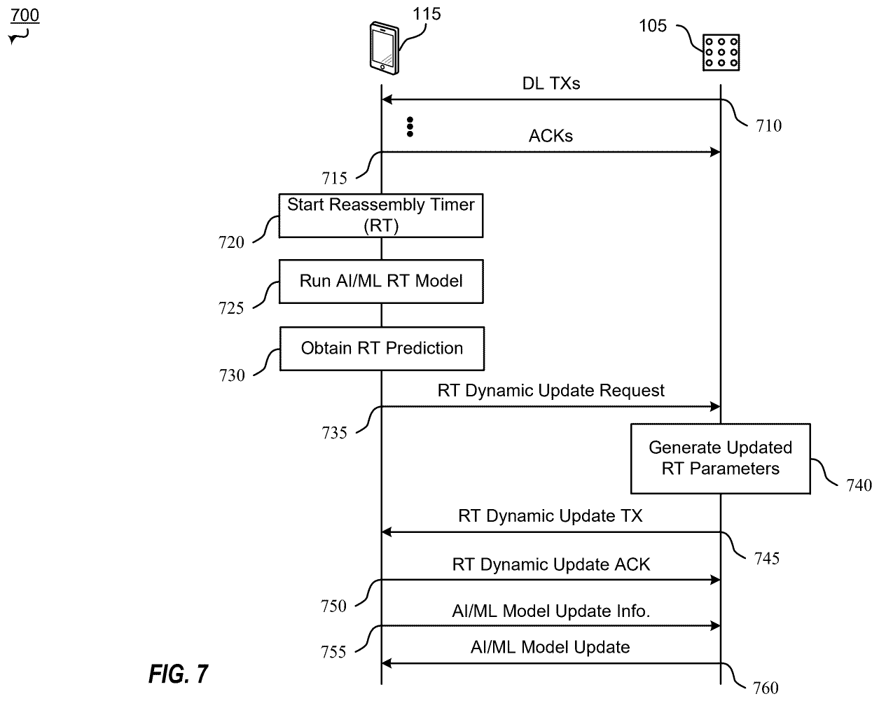

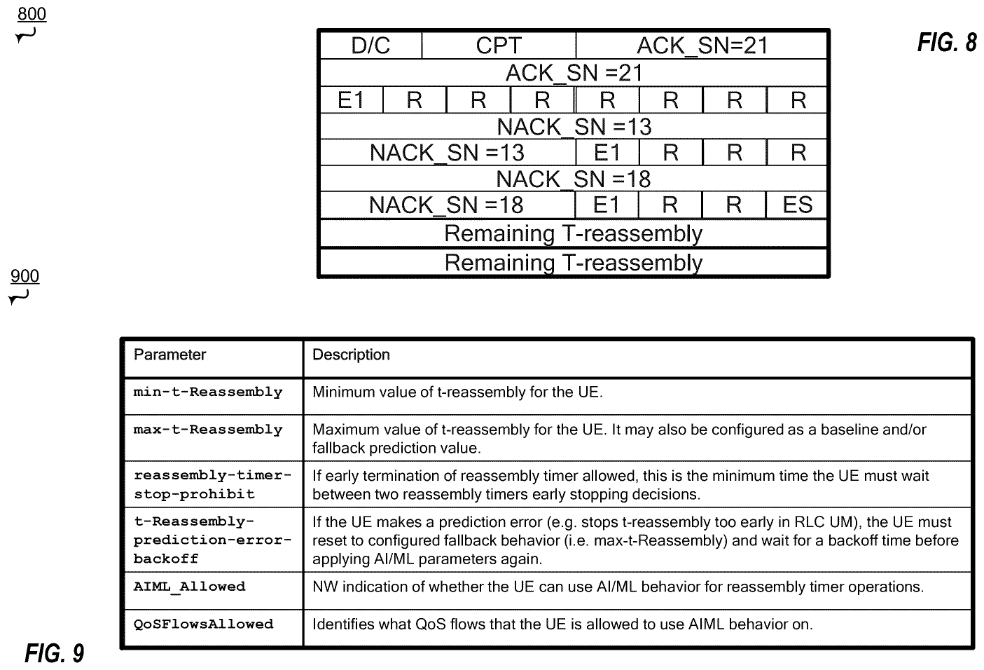

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIGS. 7 and 8, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In wireless networks, devices may acknowledge receiving data by providing feedback information. However, the data to be sent and acknowledged may be too large for a single transmission and may span multiple transmissions. Thus, the data may be broken into many chunks or units to be sent wirelessly, and each unit may be given an identifier, such as a sequence number (SN). The feedback information to acknowledge this data may be provided per unit of data, such as per SDU. SDUs may be stored at a receiving device temporarily to enable data to be sent out of order to maximize bandwidth and/or to enable SDUs to be resent in case of a reception failure.

In wireless operations, timers may be used to control operations of the temporary storing of data units. For example, a reassembly timer may be use for radio link control (RLC) service data units (SDUs) to control how long a device should wait before taking a particular action, such as clearing the stored RLC SDUs, transmitting feedback information, etc.

The reassembly timer (or RLC entity) may be configured to operate in multiple different modes, such as a Transparent Mode (TM), an Unacknowledged Mode (UM) and an Acknowledged Mode (AM). In the UM, the device does not transmit feedback information, and in the AM, the device does transmit feedback information, such as hybrid automatic repeat request (HARQ) feedback information.

The reassembly timer may be set to a network configured duration and started responsive to receipt of a RLC SDU (also referred to as a RLC segment or a RLC SDU segment) and/or determination of a hole or gap in a sequence or RLC SDUs. For example, the device may start a reassembly timer for a sequence of multiple RLC SDUs (e.g., RLCs with SNs 0-9) based on determining the device has received RLC SDUs having a SN of 0, 1, and 3 and not having received the RLC SDU having a SN of 2. The device may decrement the reassembly timer from the starting value associated with the network configured duration and engage in assembly expiration action upon expiration of the reassembly timer prior to receipt of the missing RLC SDU(s).

Additionally, the transmitting device may engage in polling operations in some modes. For example, in AM operations, the transmitting device (e.g., a base station) may transmit a polling indication (e.g., in the RLC header) to prompt the device (e.g., the UE) to provide information on received and/or missing/lost SDUs in a response transmission, such as a status PDU.

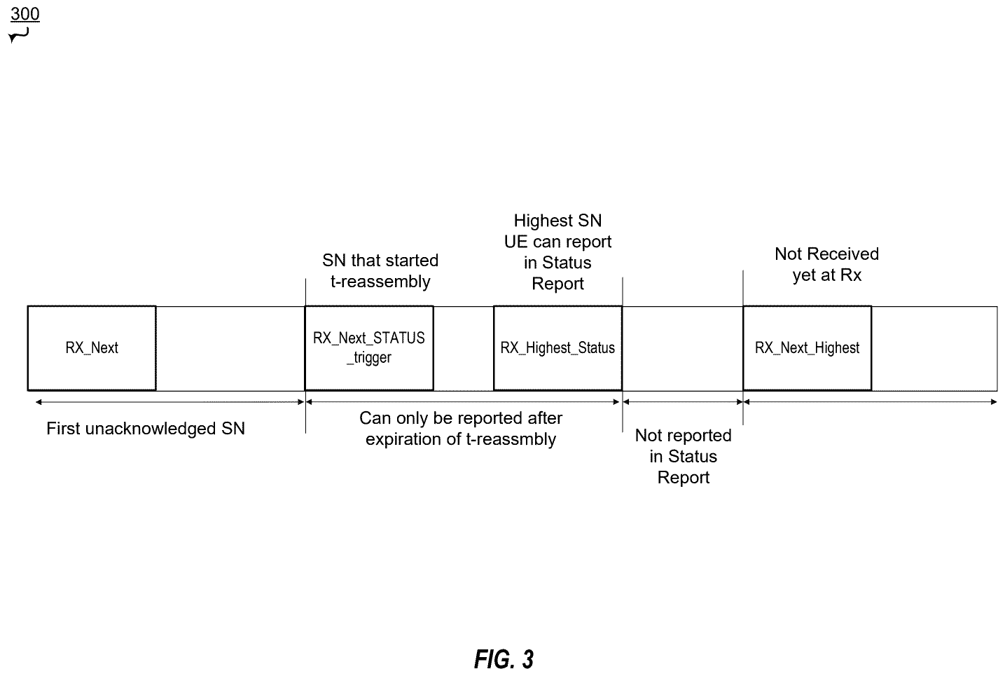

FIG. 3 illustrates an example of RLC reassembly timer operations. In FIG. 3, a diagram 300 illustrates RLC reassembly timer operations for AM. In FIG. 3, the RX_Next RLC SDU corresponds to a first unacknowledged RLC SDU, the RX_Next_STATUS_trigger corresponds to a RLC SDU that started the reassembly timer, the RX_Highest_Status corresponds to a RLC SDU that has the highest SN that the device can report in a Status PDU in response to a polling indication, and the RX_Next_Highest corresponds to a RLC SDU of the same sequence as the RX_Next RLC SDU that has not been received yet and cannot yet be reported in a Status PDU.

During operation, the device may receive RLC SDUs at a RLC entity corresponding to a particular RLC sequence. The RLC sequence may have a plurality or RLC SDUs, each with a corresponding SN. The device receives RLC SDUs and stored the RLC SDUs in a memory for reassembly (combining) responsive to receiving all of the RLC SDUs of the sequence. In the example, of FIG. 3, the device receives the RX_Next RLC SDU. The device also receives the RX_Next_STATUS_trigger RLC SDU at the same time as the RX_Next RLC SDU or after receiving the RX_Next RLC SDU. The device sets the reassembly timer to the network configured duration and starts the reassembly timer responsive to receiving the RX_Next RLC SDU. For example, the device determines a gap in SNs based on the SN of the RX_Next RLC SDU and the SN of the RX_Next_STATUS_trigger RLC SDU, and starts the reassembly timer based on determining the gap.

During running of the reassembly timer, the device may receive additional RLC SDUs of the sequence. For example, the device receives the RX_Highest_Status RLC SDU and optionally one or more RLC SDUs with lower SNs. The device may report received RLC SDUs and optionally missing RLC SDUs of the sequence in a Status PDU responsive to receiving a polling indication. For example, the device may report status information for RLC SDUs for SNs of the sequence up to the SN of the RX_Next_Highest RLC SDU.

The reassembly timer continues running and eventually expires without receipt of each RLC SDU of the sequence. The device then reports the feedback information to the network, when operating in the AM, and then the device proceeds with conventional operations triggered by expiration of the RLC timer. For example, the device may clear the RLC SDUs from the memory, the device may information other layers of the failure, etc.

In conventional operations, the reassembly timer is set pre-configured and set by the network. Reassembly timer accuracy can greatly impact the device. Setting the reassembly timer too high/long may waste time unnecessarily and cause unnecessary delay before retransmission can occur. While setting the reassembly timer too low/short may cause excessive retransmissions and failures.

In the aspects described herein, the devices of the network can engage in dynamic reassembly timer update operations to better control the Reassembly timer and adjust the reassembly timer better to the operation of the communication link. The aspects described herein provide systems and methods for adjusting reassembly timer durations and/or parameters during network operations. The enhanced dynamic reassembly timer operations enable better flexibility and accuracy in reassembly operations which provide for reduced overhead and lower latencies, which improve the user experience.

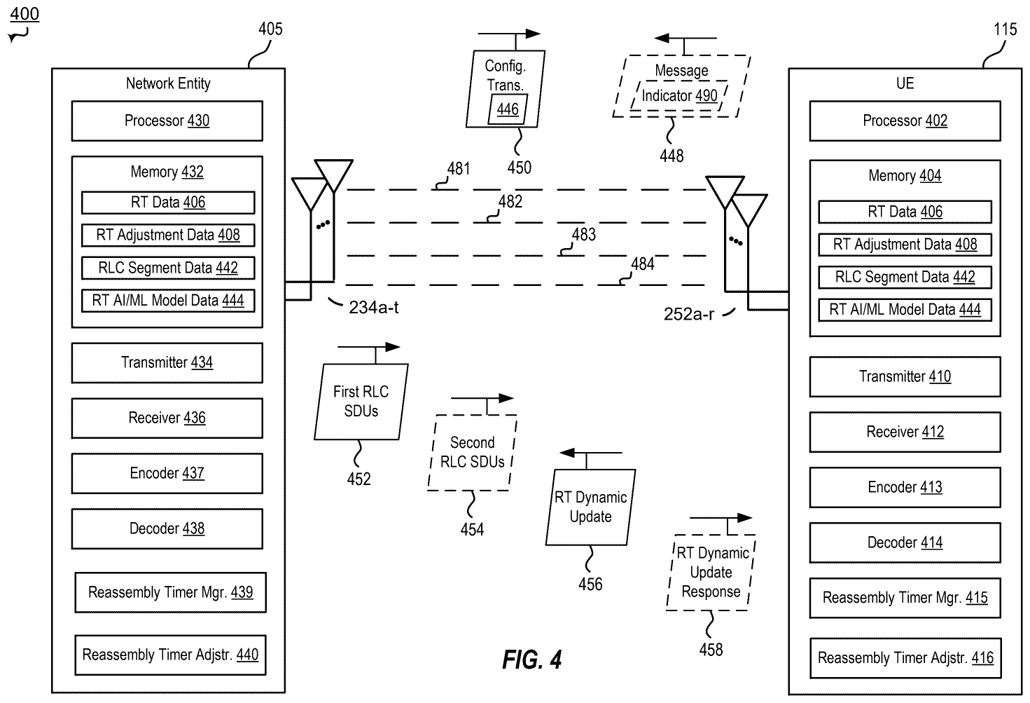

FIG. 4 illustrates an example of a wireless communications system 400 that supports enhanced dynamic reassembly timer operations in accordance with aspects of the present disclosure. In some examples, wireless communications system 400 may implement aspects of the wireless communication system of FIG. 1 (e.g., 5G network 100). For example, wireless communications system 400 may include UE 115 and network entity 405. Enhanced dynamic reassembly timer operations may improve bandwidth utilization and reduce latency and memory usage by enabling a UE to dynamically adjust or to initiate dynamic adjustments to reassembly timer durations and operations. The enhanced dynamic reassembly timer operations may include reducing reassembly timer durations and/or early termination of a reassembly timer to prompt early resending and/or recovery of the failed data. Thus, network and device performance can be increased.

Network entity 405 and UE 115 may be configured to communicate via frequency bands, such as FR1 having a frequency of 410 to 7125 MHz, FR2 having a frequency of 24250 to 52600 MHz for mm-Wave, and/or one or more other frequency bands. It is noted that SCS may be equal to 15, 30, 60, or 120 kHz for some data channels. Network entity 405 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via network entity 405 and UE 115. For example, the control information may be communicated using MAC-CE transmissions, RRC transmissions, DCI, transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, reassembly timer manager 415, reassembly timer adjuster 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store reassembly timer data 406, reassembly timer adjustment data 408, RLC segment data 442, reassembly timer AI/ML model data 444, reassembly timer settings data 446, or a combination thereof, as further described herein.

The reassembly timer data 406 includes or corresponds to data associated with or corresponding to reassembly timer. For example, the reassembly timer data 406 may correspond to data associated with a particular reassembly timer for a particular sequence or group of RLC SDUs. In some implementations, the reassembly timer data 406 further includes log data or historical data indicating previous or historical reassembly timer operations data. For example, the log data may include amount of reassembly timer errors, reassembly timer expirations, actual RLC latency, predicted RLC latency, etc.

The reassembly timer adjustment data 408 includes or corresponds to data that is associated with adjusting the reassembly timer and/or parameters thereof. The reassembly timer adjustment data 408 may include reassembly timer duration adjustment data, reassembly timer parameter adjustment data, or both. For example, the reassembly timer adjustment data 408 may include data for when and how to adjust a duration of the reassembly timer, when and how to stop the reassembly timer early, when and how to request a dynamic reassembly timer update to the network, or a combination thereof.

In some implementations, the reassembly timer adjustment data 408 further includes log data or historical data indicating previous or historical adjustments to the reassembly timer reassembly timer parameters, or both. For example, the log data may include information regarding past reassembly timer duration and/or parameter adjustments, an amount of adjustments, an amount of reassembly timer adjustment errors, predicted/estimated expected latency, etc. The log data of the reassembly timer adjustment data 408 may enable the UE 115 to inform or recommend to the network determined optimal “semi-static” values of for reassembly timer parameters along with updates after handover, observed changes of inputs, errors in predictions, etc.

The RLC segment data 442 includes or corresponds to data associated with or corresponding to received RLC SDUs. For example, the RLC segment data 442 may include or correspond to the data of or for the received RLC SDUs, including the segments thereof referred to as RLC segments. Each RLC SDU may have one or more segments. Additionally, the RLC segment data 442 may further include data indicating a particular sequence number (SN) for each RLC SDU indicating an associated sequence for each RLC SDU (and any segments thereof).

The reassembly timer AI/ML model data 444 (also referred to as AI/ML model data 444) includes or corresponds to AI or ML models for one or more reassembly timer-related systems or modules of the UE 115. For example, the UE 115 may include a single AI or ML model for reassembly timer operations, such as a single AI or ML model associated with one or more of the reassembly timer manager 415 and/or the reassembly timer adjuster 416. To illustrate, the AI or ML model for the reassembly timer enhancement operations may receive one or more physical layer statistics and/or parameters as input and may output a reassembly timer adjustment.

As another example, the reassembly timer enhancement operations may include multiple discrete AI or ML modules for different portions of the reassembly timer enhancement operations. To illustrate, the UE 115 may include an AI or ML module for reassembly timer management by the reassembly timer manager 415, and an AI or ML module for reassembly timer adjustment by the reassembly timer adjuster 416. Each AI or ML module may have corresponding inputs and outputs as described herein with respect to each of the corresponding modules or components.

In some such implementations, one or more of the above AI or ML modules may have one or more AI or ML sub-modules or may be further broken into multiple discrete AI or ML sub-modules for different portions. For example, the AI or ML module for reassembly timer adjustment by the reassembly timer adjuster 416 may include or correspond to an AI or ML module for reassembly timer adjustment probability calculation, an AI or ML module for reassembly timer adjusted duration calculation, an AI or ML module for reassembly timer adjusted parameter calculation, or a combination thereof.

In some implementations, the reassembly timer AI/ML model data 444 may include log data. The log data of the reassembly timer AI/ML model data 444 may indicate errors in prediction (e.g., underprediction/overprediction of reassembly timer values) to an AI/ML server to update the AI/ML model or models for dynamic reassembly timer operations. The UE 115 may inform the network of such errors and any related fallback actions, such as if reassembly timer is underpredicted the UE 115 falls back to a configured value.

In some implementations, the reassembly timer AI/ML model data 444 includes logs for input parameters. For example, the input parameter log information of the reassembly timer AI/ML model data 444 may include information for one or more of an amount of retransmissions, an amount of physical resource blocks (PRBs) used, a MIMO configuration of the transmissions, a modulation coding scheme (MCS) of the transmission, physical (PHY) layer parameters, a transport block size, channel quality metrics, HARQ round trip time (RTT), channel parameters, etc.

The channel parameter information includes or corresponds to data associated with or corresponding to a channel or communication link of the device, such as channel parameters that are relevant to dynamic reassembly operations. For example, the channel parameter information may indicate information for parameters of the channel or communication link and relevant to the reassembly timer data 406. Exemplary channel or link parameters may include a RSRP of a channel or link, a RSRP difference of a channel or link, a time alignment timer (TAT), a packet delay budget (PDB), or a combination thereof.

The log data of the reassembly timer AI/ML model data 444 may enable the UE 115 to have advanced capabilities in reporting information to enable AI/ML updates or optimizations. The UE 115 may be configured to store and report information related to AI/ML model and performance thereof. To illustrate, the UE 115 may be configured to report its inputs, outputs, constraints, and performance metrics related to reassembly timer related predictions and operations.

As illustrative example, the UE 115 may log data into information elements to collect the data to support the AI/ML model, and this may include labels, metadata, timestamps, etc. The UE 115 may log data on multiple different levels and/or with different granularity to support data reporting for AI/ML updates or optimizations. For example, the UE 115 may log, with respect to a UE level, RLC level or LCH level information, and with respect to a data plane level, the reporting may include user plane related information. As another example, on a protocol/entity level (e.g., packet data convergence protocol (PDCP) layer, RLC layer, etc.) the UE 115 may log RLC related information, and on a parameter level UE 115 may log reassembly timer parameter related information. Additionally, or alternatively, the UE 115 may log one or more of estimated latency, probability distributions, confidence values, adjusted reassembly timer parameters, reassembly timer termination, update requests, or model accuracy/performance. The latency probability distribution reporting may include indications for reporting latency probability distribution for RLC SDUs for UM operations, latency probability distribution as a function.

The reassembly timer settings data 446 (also referred to as settings data 446) includes or corresponds to data associated with reassembly timer operations. The settings data 446 may include one or more types of reassembly timer operational modes, and/or thresholds or conditions for switching between reassembly timer operational modes and/or configurations. For example, the settings data 446 may have data indicating different dynamic reassembly timer conditions or thresholds for different reassembly timer operational modes, such as TM, UM, AM, etc. As another example, the settings data 446 may have data indicating which QoS flows are available for enhanced (AI/ML dynamic updates) reassembly timer operations.

The reassembly timer settings data 446 may include reassembly timer configuration data, such as dynamic reassembly timer configuration data. The reassembly timer settings data 446 may include RRC configuration information, such as RLC parameters or information elements. The dynamic reassembly timer configuration data may include or correspond to the dynamic reassembly timer configuration data of FIG. 9 in some implementations.

The reassembly timer settings data 446 may also include reassembly timer conditions data indicating conditions or thresholds for getting reassembly timer update related outputs (e.g., adjust timer, terminate timer, etc.) based on intermediate AI/ML reassembly timer based outputs, such as expected latency and/or probability/confidence.

The reassembly timer settings data 446 may further include reassembly timer reporting settings data indicating settings and/or conditions or thresholds for reporting reassembly timer data reporting capabilities and report data. For example, the reassembly timer reporting settings data may include data for the UE 115 to indicate its capabilities for enhanced reassembly timer operation data reporting, include reporting data related to AI/ML model and performance thereof. To illustrate, the UE 115 may be configured to report its inputs, outputs, constraints, and performance metrics related to reassembly timer related predictions and operations.

The capabilities reporting information may include indications for different levels of granularity in the reporting and to enable and/or update the AI/ML model. For example, on a UE level the capabilities reporting may include indications for reporting RLC level or LCH level information, and with respect to data planes, the reporting may include user plane related information. As another example, on a protocol/entity level (e.g., PDCP, RLC, etc.) the capabilities reporting information may include indications for reporting RLC related information, and on a parameter level the capabilities reporting information may include indications for may include reassembly timer parameter related information.

The capabilities reporting information may further include indications for reporting AI native capabilities at the UE, such as the UE's ability to estimate latency, probability distributions, confidence values, adjusted reassembly timer parameters, reassembly timer termination, update requests, or model accuracy/performance. The latency probability distribution reporting may include indications for reporting latency probability distribution for RLC SDUs for UM operations, latency probability distribution as a function of STATUS reporting for AM operations, or both.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmissions, such as transmissions with RLC SDU segments. The reassembly timer manager 415 may be configured to determine and perform reassembly timer operations, such as enhanced or dynamic reassembly timer operations. For example, the reassembly timer manager 415 is configured to perform reassembly timer operations in one or more modes, such as TM, UM, and/or AM, and is configured to control or coordinate dynamic adjustments or updates to the reassembly timer and/or parameters thereof.

The reassembly timer adjuster 416 may be configured to perform dynamic reassembly timer adjustment operations. For example, the reassembly timer adjuster 416 may be configured to determine when to perform dynamic reassembly timer adjustment operations. To illustrate, the reassembly timer adjuster 416 may be configured to determine a probability that an adjustment will result in an improvement, or wither an AI/ML determined output or outputs satisfies a corresponding condition or conditions for adjusting the reassembly timer operations. As another example, the reassembly timer adjuster 416 may be configured to determine how to perform dynamic reassembly timer adjustment operations. To illustrate, the reassembly timer adjuster 416 may be configured to determine an amount of time to adjust a duration of a reassembly timer.

Network entity 405 includes processor 430, memory 432, transmitter 434, receiver 436, encoder 437, decoder 438, reassembly timer manager 439, reassembly timer adjuster 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store reassembly timer data 406, reassembly timer adjustment data 408, RLC segment data 442, reassembly timer AI/ML modes data 444, reassembly timer settings data 446, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, network entity 405 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of network entity 405 described with reference to FIG. 2.

Encoder 437, and decoder 438 may include the same functionality as described with reference to encoder 413 and decoder 414, respectively. Reassembly timer manager 439 may include similar functionality as described with reference to reassembly timer manager 415. reassembly timer adjuster 440 may include similar functionality as described with reference to reassembly timer adjuster 416.

During operation of wireless communications system 400, network entity 405 may determine that UE 115 has enhanced reassembly timer capabilities, such as dynamic reassembly timer operational capabilities. For example, UE 115 may transmit a message 448 that includes a dynamic reassembly timer indicator 490. Indicator 490 may indicate dynamic reassembly timer operational capability or a particular type or mode of dynamic reassembly timer operation. In some implementations, network entity 405 sends control information to indicate to UE 115 that dynamic reassembly timer operations and/or a particular type of dynamic reassembly timer operation is to be used. For example, in some implementations, message 448 (or another message, such as configuration transmission 450) is transmitted by the network entity 405. The configuration transmission 450 may include reassembly timer settings data 446 (e.g., reassembly timer configuration data). Additionally, or alternatively, the configuration transmission 450 may indicate to use dynamic reassembly timer operations or to adjust or implement a setting of a particular type of dynamic reassembly timer operations. In some implementations, the reassembly timer settings data 446 may include data configurations for advanced capabilities reporting, such as reporting of AI/ML related data and reassembly timer related data to support AI/ML updates or optimizations.

During enhanced reassembly timer operations, devices of wireless communications system 400 perform dynamic reassembly timer operations to adjust reassembly timer operations and/or parameters. For example, the network entity 405 and the UE 115 may exchange transmissions which causes the UE 115 to set a reassembly timer to the reassembly timer configuration and start the reassembly timer, and to perform dynamic reassembly timer operations during operation of the reassembly timer. In the example of FIG. 4, the network entity 405 transmits first RLC SDUs 452 to the UE 115. To illustrate, a base station transmits downlink data transmission, such as PDSCH transmission, that includes one or more RLC SDUs. The RLC SDUs of the first RLC SDUs 452 may be part of one or more sequences or groups of RLC SDUs and have an associated SN or SNs. A RLC SDU of the first RLC SDUs 452 may include one or more segments thereof. An RLC SDU with a single segment may be considered an unsegmented or whole RLC SDU. The UE 115 stores the received RLC SDUs in a memory or buffer, such as a RLC SDU buffer. For example, a RLC entity or the reassembly timer manager 415 stores the one or more first RLC SDUs in or as a portion of the RLC segment data 442 and along with their corresponding SN.

The network entity 405 optionally transmits second RLC SDUs 454 to the UE 115. To illustrate, a base station transmits a second downlink data transmission, such as second PDSCH transmission, that includes one or more second RLC SDUs. The second RLC SDUs of the second RLC SDUs 454 may be part of one or more sequences or groups of RLC SDUs and have an associated SN or SNs. A RLC SDU of the second RLC SDUs 454 may include one or more segments thereof. In some implementations, the second RLC SDU(s) are part of the same sequence or group as the first RLC SDUs. The UE 115 stores the received second RLC SDUs in the memory or buffer, such as the RLC SDU buffer. For example, the RLC entity or the reassembly timer manager 415 stores the one or more second RLC SDUs in or as a portion of the RLC segment data 442 and along with their corresponding SN.

After receipt of the first RLC SDUs, and optionally second RLC SDUs, the UE 115 may determine to at least one RLC SDU is missing or not yet received based on an associated SN. For example, the UE 115 may determine that there is a gap in SNs of received RLC SDUs, similar to as described with reference to FIG. 3. To illustrate, the UE 115 determines it has received a RLC SDU with a SN, SN(X+2) that is at least two values higher than a highest SN received, SN(X), leaving a gap of at least one SN, SN(X+1). As an illustrative example, third RLC SDUs (not shown) may have been sent by the network entity 405 and not been received by the UE 115, or one or more of the first or second RLC SDUs that were transmitted by the network entity 405 were not successfully received and decoded by the UE 115. Thus, the UE 115 determines it is missing at least one RLC SDU corresponding to the gap or missing SN, i.e., RLC SDU with SN(X). Upon determining that at least one RLC SDU is missing, the UE 115 starts the reassembly timer for the missing RLC SDU, RLC SDU with SN(X), and optionally for the entire sequence, e.g., RLC SDUs with a SN from SN(X−n) to SN(X+m). For example, the reassembly timer manager 415 sets the reassembly timer data 406 to a default or base expiration time or duration indicated by the reassembly timer settings data 446 (e.g., configuration information thereof).

The UE 115 may perform enhanced reassembly timer operations, such as dynamic reassembly timer operations to evaluate whether to dynamically adjust the reassembly timer or parameters thereof based on the received RLC SDUs and the operations of the UE 115. For example, the UE 115 may perform AI/ML-based evaluations of reassembly timer operations responsive to receiving the RLC SDUs and/or starting of the reassembly timer.

To illustrate, the reassembly timer adjuster 416 utilizes the reassembly timer AI/ML model data 444 to perform evaluations on the success and/or probability of the reassembly timer operations. As one illustrative example, the reassembly timer adjuster 416 determines two outputs, a probability output related to a likelihood that a particular SN or sequence be received before expiration of the reassembly timer and an expected latency output of a particular a RLC SDU SN. The reassembly timer adjuster 416 may further determine if the expected latency will extend past expiration of the reassembly timer, a PDB-related threshold, or both, in some implementations.

In some implementations, the probability output is or corresponds to a probability distribution of when the sequence or group of SNs will be completely received and whether it is likely that they will not be received before expiration of the reassembly timer, or when a particular SN will be received and whether it is likely that the particular SN will not be received before expiration of the reassembly timer. For example, the probability output may be a value indicating a probability value or probability distribution expiration of the reassembly timer. As one illustrative, non-limiting example, the probability output may be a probability distribution of the true reassemble timer value given (e.g., for or over) an observed window of past received SDUs and HARQ events, P(t-reassembly|Observed window, HARQ events). The true reassembly timer (true t-reassembly) may correspond to a time after which we know that reassembly timer will definitely expire for sure, that is a particular SDU would not be received without feedback.

Additionally, or alternatively, the expected latency output of a particular RLC SDU SN may corresponds to an expected latency value given (e.g., for or over) an observed window of past received SDUs and HARQ events, E[T_{SN, Latency}|Observed window, HARQ events]. The expected latency output is the expected value of a certain latency of any SDU or a particular SDU. For example, the expected latency output may indicate on average how long it will take for SDU with a certain SN (say SN=10) to be delivered to the receive buffer.

Additionally, or alternatively, the reassembly timer adjuster 416 utilizes the reassembly timer AI/ML model data 444 to generates other or additional outputs. For example, the reassembly timer AI/ML model data 444 may also output a particular recommended adjustment or may output the recommended adjustment in the alternative of reassembly timer operational estimations or statistics. To illustrate, the reassembly timer adjuster 416 may generate an indication of early termination or a particular adjusted duration or other reassembly timer parameter based on using the AI/ML model data 444. Such outputs may correspond to general predictions on sequence or PDU arrival time and/or to determined optimized reassembly timer parameter values.

Depending on the desired outputs, the AI/ML model data 444 may use different sets of inputs. As illustrative, non-limiting examples of the inputs to or used by the model, the inputs include information for an amount of retransmissions, an amount PRBs used, a MIMO configuration of the transmissions, an MCS of the transmission, PHY layer parameters, a transport block size, channel quality metrics, HARQ RTT, etc., or any combination thereof. The AI/ML model data 444 may also use historical performance data for reassembly timer operations for the UE 115, information regarding the particular RLC SDUs, such as amount missing, sequence length, QoS type.

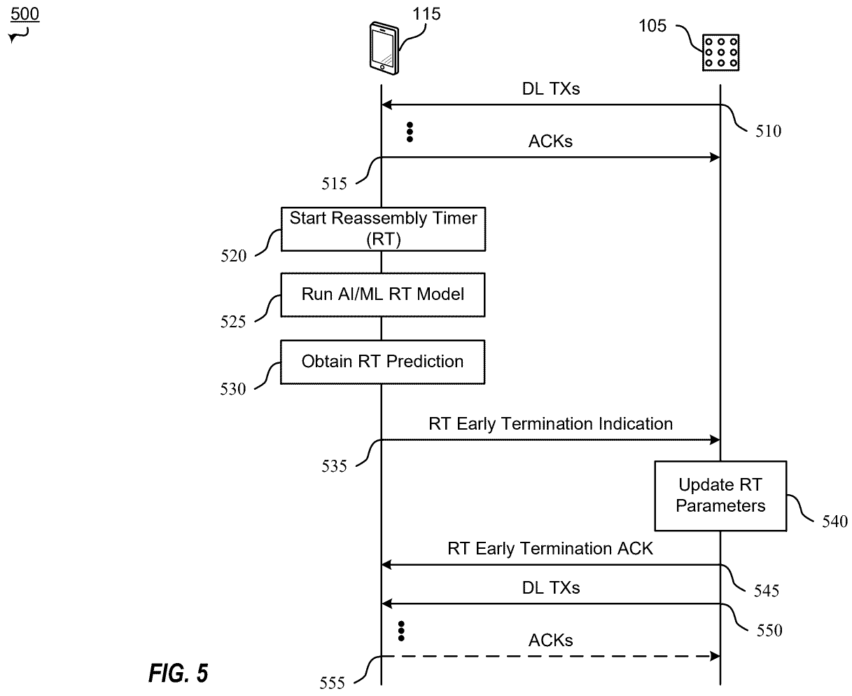

The UE 115 determine whether to dynamically update the reassembly timer based on the AI/ML evaluations of the reassembly timer operations. For example, the UE 115 may determine whether to stop the reassembly timer early, whether to provide updated reassembly timer parameters to the network, or whether to request a reassembly timer update from the network based on an AI/ML evaluations, a set of conditions, or a particular network configuration or mode (e.g., early termination mode, UE update mode, UE request mode, AM, UM, etc.). To illustrate, the UE 115 may determine to perform early termination based dynamic reassembly timer updates based on a network configuration (e.g., AI/ML updates permitted and/or early termination permitted) and optionally based on a RLC mode, such as UM operations. Examples of different type of dynamics updates, such as early termination, UE update, and UE request, are further described herein with reference to FIGS. 5-7.

The UE 115 determining whether to dynamically update the reassembly timer based on the AI/ML evaluations of the reassembly timer operations may further include an evaluation of how to adjust the reassembly timer operations or how much to adjust the reassembly timer parameters. For example, after the UE 115 has utilized the reassembly timer AI/ML model data 444 to generate one or more outputs, the UE 115 may evaluate the outputs and/or the reassembly timer settings data 446 to determine how to adjust the reassembly timer operations. To illustrate, the UE 115 may adjust (e.g., shorten) the reassembly timer duration by X ms or cycles responsive to an output indicating that the reassembly timer duration is too long, such as by the AI/ML output indicating a sequence or SN will not be received within the original expiration time, and optionally based on a probability or confidence value output being greater than a threshold. As another illustration, the UE 115 may use a set of conditions or thresholds to determine between a set of fixed amounts or may use a formula, database (e.g., table) or AI/ML models to calculate a particular adjustment value for the duration based on one or more outputs from the AI/ML based evaluation of the reassembly timer operations. In some such implementations, the adjustments to reassembly timer or parameters may be bounded by certain network or pre-configured thresholds or limits. As an illustrative example, if the UE 115 can predict an estimated expiration of the reassembly timer confidently (e.g., confidence score or probability distribution above a threshold) 20 ms before the original expiration time then the UE can confidently reduce the current reassembly timer by 20 ms or less, and optionally future reassembly timers by 20 or less ms, because the probability of receiving the missing RLC SDUs (e.g., the complete PDU) is low.

Additionally, or alternatively, the UE 115 may determine whether or how to adjust reassembly timer parameters. For example, the UE 115 may determine to adjust the amount of time added or subtracted during changes to the reassembly timer duration. To illustrate, the UE 115 may determine to adjust the amount of time added or subtracted during changes based on historical reassembly timer performance data and/or current link conditions.

In other implementations, the UE 115 may not determine how to dynamically update the reassembly timer. In some such implementations, the UE 115 may determine or may be configured to just report the AI/ML determined outputs to the network, for use by the network in determining a particular update for the reassembly timer.

The UE 115 transmits a reassembly timer dynamic update transmission 456 including reassembly timer dynamic update indication. For example, the UE 115 transmits a message including a reassembly timer dynamic update indication that indicates an early termination of the reassembly timer, a change to the reassembly timer, or a request to update the reassembly timer. To illustrate, the UE 115 may transmit a data or control transmission with bit or flag indicating early termination or a request to dynamically update the reassembly timer. Additionally, the UE 115 may optionally provide information regarding the desired update, request or early termination, such as the AI/ML outputs relied on by the UE 115, the amount of time remaining on the reassembly timer (or amount of time the reassembly timer was changed), or an amount of change to a reassembly timer parameter. The reassembly timer dynamic update transmission 456 may include or correspond to a PUCCH, a PUSCH, a MAC CE, or a RRC transmission. In some implementations, the reassembly timer dynamic update transmission 456 corresponds to a status PDU message, such as a status PDU as illustrated in FIG. 8.

After the transmission of the reassembly timer dynamic update transmission 456, the network may update the reassembly timer or reassembly timer operations. In the example of FIG. 4, the network entity 405 transmits a reassembly timer dynamic update response transmission 458 to the UE 115 including a reassembly timer dynamic update response indication. The reassembly timer dynamic update response indication is configured to indicate or confirm that a change or update to the reassembly timer or reassembly timer operations has occurred. To illustrate, the network entity 405 may transmit a PDCCH, a PDSCH, a MAC CE, or a RRC transmission to the UE 115 to indicate confirmation of receipt and implementation of the UE indicated early termination of the current reassembly timer or the UE indicated change in reassembly timer operations in implementations where the UE can dynamically update thee reassembly timer. As another illustration, the network entity 405 may transmit a PDCCH, a PDSCH, a MAC CE, or a RRC transmission to the UE 115 to indicate acceptance or denial of a UE request change or to indicate a particular network determined early termination of the current reassembly timer or a particular network determined change in reassembly timer operations in implementations where the UE can only request dynamic updates for the reassembly timer to the network and/or provides AI/ML output information to the network (e.g., intermediate information or statistics related to AI/ML evaluations such as expected latency and probability distribution.

Additionally, or alternatively, the reassembly timer dynamic update response transmission 458 may include updated or revised reassembly timer configuration information. For example, the reassembly timer dynamic update response transmission 458 may include reassembly timer settings data 446 with a new or update performance target metric for reassembly timer operations and/or with updated reassembly timer parameters. As an illustrative example, the reassembly timer dynamic update response transmission 458 may include a RRC transmission including one or more of the parameters of the reassembly timer configuration information as illustrated in FIG. 9.

After receipt of the reassembly timer dynamic update response transmission 458, the UE 115 may update the reassembly timer or reassembly timer operations. For example, the UE 115 may update a duration for future reassembly timers, send HARQ-ACK feedback for SNs where the UE or network determined to terminate the reassembly timer early, change a reassembly timer parameter, reset reassembly timer parameters to network configured parameters, perform an AI/ML model update or model switch, transmit log or AI/ML model information to the network entity 405 or another device (e.g., AI/ML server), or a combination thereof.

Upon expiration of the currently running reassembly timer for the first and second RLC SDUs (or the early terminated reassembly timer for the first and second RLC SDUs), the UE 115 may perform conventional operations which are triggered by expiration of a reassembly timer. For example, in AM mode operations the UE 115 may provide HARQ feedback upon expiration of the currently running reassembly timer. As another example, in UM and AM mode operations the UE 115 may clear the RLC SDUs from the memory and provide indications to other layers, such as for PDCP reordering, upon expiration of the currently running reassembly time. The indication or indications from the RLC layer to the PDCP may be used by the PDCP layer to perform reordering operations or to adjust a corresponding PDCP recording timer (t-reordering).

In some such implementations, the RLC entity or layer provides the adjusted duration of the reassembly timer or the early termination of the reassembly timer to a PDCP entity or layer, and the PDCP entity or layer may use this information to selector derive a new recommended value for t-new-reordering. Additionally, or alternatively, the RLC entity or layer provides the AI/ML outputs to a PDCP reordering adjuster or the PDCP entity or layer, and the PDCP reordering adjuster and/or the PDCP entity/layer may use this information to derive a new recommended value for t-new-reordering.

Accordingly, the UE 115 and network entity 405 may be able to perform reassembly timer operations more efficiently by enabling dynamic adjustments to reassembly timer parameters and operations, which reduces network bandwidth and latency due to more optimized and efficient RLC reassembly operations. Thus, FIG. 4 describes reassembly timer enhancements for dynamic reassembly timer operations. Using dynamic reassembly timer operations may reduce memory consumption and latency by enabling a UE to shorten the reassembly timer or end the reassembly timer early when the likelihood of receiving the missing RLC SDUs. Performing enhanced dynamic reassembly timer operations thus enables enhanced UE and network performance by increasing reducing latency for the network as a whole.

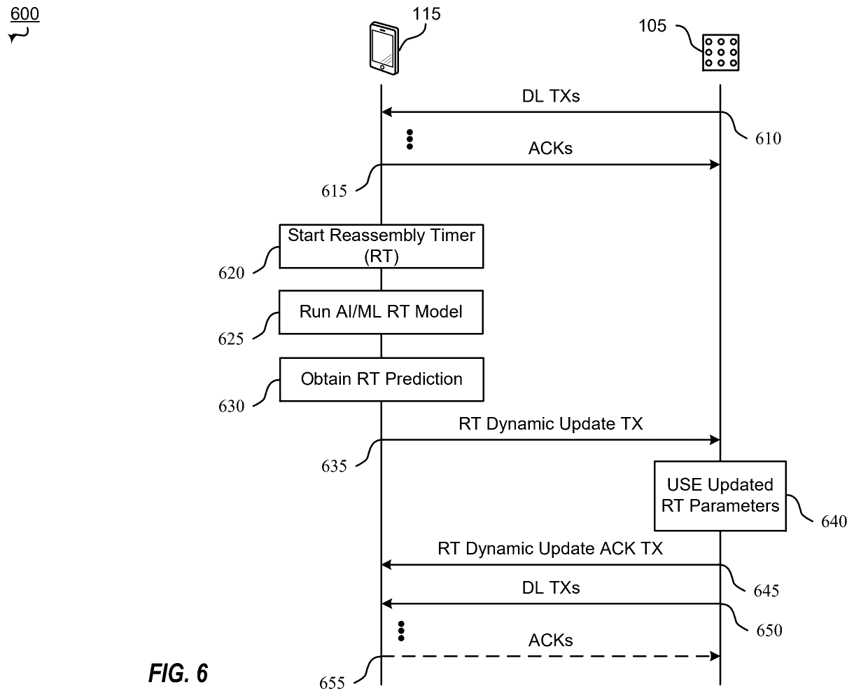

FIGS. 5-7 illustrate examples of ladder diagrams for enhanced dynamic reassembly timer operations. Referring to FIG. 5, FIG. 5 is a ladder diagram 500 of dynamic reassembly timer operations with early termination. In the example of FIG. 5, the ladder diagram 500 illustrates a UE and a network entity, such as network entity 405 (e.g., base station 105). Referring to FIG. 6, FIG. 6 is a ladder diagram 600 for dynamic reassembly timer operations with reassembly timer adjustment. In the example of FIG. 6, the ladder diagram 600 illustrates a UE and a network entity, such as base station 105. Referring to FIG. 7, FIG. 7 is a ladder diagram 700 illustrating dynamic reassembly timer operations with a reassembly timer update request. In the example of FIG. 7, the ladder diagram 700 illustrates a UE and a network entity, such as base station 105.

Referring to FIG. 5, early termination operations are illustrated for dynamic reassembly timer operations. For example, in FIG. 5, a device performs dynamic reassembly timer evaluation operations and determines to perform early termination of the reassembly timer. In the example of FIG. 5, the device may receive information for setting the reassembly timer from the network, determine to start the reassembly timer based on downlink data transmissions from the network, and determine to end the reassembly timer before the original set/configured time based on performing AI/ML analysis on the channel, the received SDUs, and the performance history. Early termination of the reassembly timer by the device may enable the device to release the SDUs early which reduces memory usage, reduces excessive and unnecessary delay/latency, and may initiate feedback procedures (e.g., in AM operations). Reducing the memory may help facilitate transmission bursts with less memory and/or enable larger transmission bursts.

In the example of FIG. 5, the devices may engage in downlink and uplink transmissions. Prior to the operations illustrated in FIG. 5, the UE 115 receives reassembly timer configuration information, such as described with reference to FIG. 4. For example, the UE 115 may receive a configuration transmission or a transmission upon connection or setup which includes reassembly timer configuration information, and which indicates a default or base reassembly timer duration, such as configuration transmission 450 including reassembly timer settings data 446.

During operations, the UE 115 receives downlink transmissions from a base station 105 at 510. For example, the UE 115 may receive one or more downlink transmissions, and each downlink transmission may include one or more RLC SDUs (e.g., a PPDU that includes one or more RLC SDUs). Each RLC SDU may have or be associated with a corresponding SN, and a set of the RLC SDUs may be grouped together. The UE 115 may store the RLC SDUs in a buffer until an entire group (e.g., sequence) of the RLC SDUs are received, as described with reference to FIG. 3.

At 515, the UE 115 may optionally transmit one or more acknowledgement transmissions for the downlink transmissions from the base station 105. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of a reassembly timer.

At 520, the UE 115 determines to start a reassembly timer based on the transmissions from a base station 105. For example, the UE 115 may determine a “hole” or “gap” in received RLC SDUs, or a sequence or group thereof, based on SNs of the received RLC SDU. The UE 115 may then start the reassembly timer for one or more of the RLC SDUs, and corresponding SNs. The UE 115 may set the reassembly timer to a duration indicated by the reassembly timer configuration information from the network and determine an original or network configured reassembly timer duration and expiration time.

At 525, the UE 115 performs dynamic reassembly timer update operations. For example, the UE 115 may perform AI/ML analysis on whether the missing RLC SDUs of the group or sequence will be received within the original or network configured reassembly timer duration and prior to the original or network configured expiration time. To illustrate, the UE 115 may utilize the reassembly timer adjuster 416 to perform AI/ML operations using the AI/ML model information and based on the input parameters described with reference to FIG. 4 and optionally any UE or network imposed constraints, such as those described with reference to FIGS. 4 and 9 (e.g., min. or max. duration values). The UE 115 (e.g., the reassembly timer adjuster 416 thereof) may output one or more parameters regarding the reassembly timer operations. For example, the reassembly timer adjuster 416 may output a prediction of whether the reassembly timer operation will succeed or fail and a probability or confidence value of its prediction. As another example, the reassembly timer manager 415 or the reassembly timer adjuster 416 may output an indication to stop the reassembly timer, that is to end the reassembly timer early, or to stop the reassembly timer at a particular time, such as to end the reassembly timer at some point in the future and if the RLC SDUs are not received by then.

At 530, the UE 115 determines to dynamically update the reassembly timer and to stop the reassembly timer prior to expiration. For example, the reassembly timer adjuster 416 may use the AI/ML model data 444 to generate an output regarding whether or not to stop the reassembly timer prior to the originally configured expiration time. To illustrate, the reassembly timer adjuster 416 may output a probability distribution output and an expected latency output and use the outputs to determine whether to end the reassembly timer early. The reassembly timer adjuster 416 may use a second AI/ML model of the AI/ML model data 444 which uses outputs (e.g., intermediary outputs) from a first AI/ML model of the AI/ML model data 444 to determine to perform an early termination update indication. As another example, the reassembly timer manager 415 may receive one or more outputs from the reassembly timer adjuster 416, and generated using the AI/ML model data 444, and the reassembly timer manager 415 may determine whether to stop the reassembly timer early or not based on one or more early termination conditions of the reassembly timer settings data 446. To illustrate, the reassembly timer manager 415 may compare the outputs (e.g., intermediary outputs) from an AI/ML model of the AI/ML model data 444 to corresponding thresholds, such as probability distribution or confidence value threshold and a latency threshold (e.g., the original or currently configured expiration time or duration of the reassembly timer).

At 535, the UE 115 transmits a reassembly timer early termination indication. For example, the UE 115 transmits a reassembly timer early termination indication to the base station 105 to indicate that the UE 115 has determined to stop the reassembly timer early and prior to the network configured duration. In some implementations, the UE 115 transmits a particular bit or flag to indicate early termination of the reassembly timer. The bit or flag may be sent in a reassembly timer dynamic update transmission, such as the reassembly timer dynamic update transmission 456 of FIG. 4, or a status PDU, such as the status PDU message of FIG. 8. An illustrative example, of a reassembly timer early termination indication is illustrated and described with reference to FIG. 8.

Additionally, or alternatively, the UE 115 transmit an indication of how much the UE 115 adjusted the reassembly timer, how much time was remaining on the reassembly timer when it was ended early, the confidence value or probability the UE 115 determined, or a combination thereof. In some such implementations, an amount of time indicated by the UE 115 may correspond to a quantized amount. For example, the amount of time the reassembly timer was adjusted or the amount of time remaining on the reassembly timer when stopped early may be rounded to a nearest whole number, such as X ms or X cycles.

The UE 115 may then proceed with conventional operations after expiration of a reassembly timer after the UE 115 ends the reassembly timer early or after it notifies the network that it ended the reassembly timer early. For example, the UE 115 may engage in PDCP layer operations (e.g., PDCP reordering), memory flushing operations, HARQ feedback operations, etc.

After 535, the UE 115 optionally transmits one or more acknowledgement transmissions based on the reassembly timer early termination indication. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of a reassembly timer.

At 540, the base station 105 optionally determines to update one or more reassembly timer parameters based on the reassembly timer early termination indication. For example, the base station 105 determines to update reassembly timer parameters based on receiving the reassembly timer early termination indication from the UE 115. The reassembly timer parameters may include the reassembly timer duration, a reassembly timer duration adjustment amount, reassembly timer duration adjustment parameters, reassembly timer early termination parameters, or a combination thereof.

At 545, the base station 105 optionally transmits a reassembly timer early termination acknowledgement transmission based on the reassembly timer early termination indication. For example, the base station 105 transmits a reassembly timer early termination acknowledgement transmission responsive to the received reassembly timer early termination indication from the UE 115.

At 550, the base station 105 optionally retransmits one or more downlink transmissions based on the reassembly timer early termination indication. For example, the base station 105 may determine to retransmit one or more RLC SDUs to the UE 115 based on the received reassembly timer early termination indication from the UE 115.

At 555, the UE 115 may optionally transmit one or more acknowledgement transmissions for the retransmitted downlink transmissions from the base station 105 at 550. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of a reassembly timer.

Referring to FIG. 6, dynamic reassembly timer update operations are illustrated for dynamic reassembly timer operations. For example, in FIG. 6, a device performs dynamic reassembly timer evaluation operations and determines to dynamically adjust or update the reassembly timer. In the example of FIG. 6, the device may receive information for setting the reassembly timer from the network, determine to start the reassembly timer based on downlink data transmissions from the network, and determine to adjust the reassembly timer from the original set/configured time based on performing AI/ML analysis on the channel, the received SDUs, and the performance history. Dynamic adjust of the reassembly timer by the device may enable the device to extend the reassembly timer to enable the RLC SDUs to be received in time, and thus prevent RLC recovery operations for small extensions of the reassembly timer. Additionally, dynamic adjust of the reassembly timer by the device may enable the device to release the SDUs early which reduces memory usage, reduces excessive and unnecessary delay/latency, and may initiate feedback procedures (e.g., in AM operations). Reducing the memory may help facilitate transmission bursts with less memory and/or enable larger transmission bursts.

As compared to the example of FIG. 5 where the device indicates early termination or expiration, the example of FIG. 6 provides a dynamic reassembly timer update indicating a new reassembly timer duration or expiration, or a new parameters for dynamic reassembly timer operations.

In the example of FIG. 6, the devices may engage in downlink and uplink transmissions. Prior to the operations illustrated in FIG. 6, the UE 115 receives reassembly timer configuration information, such as described with reference to FIG. 4. For example, the UE 115 may receive a configuration transmission or a transmission upon connection or setup which includes reassembly timer configuration information, and which indicates a default or base reassembly timer duration, such as configuration transmission 450 including reassembly timer settings data 446.

During operations, the UE 115 receives downlink transmissions from a base station 105 at 610. For example, the UE 115 may receive one or more downlink transmissions, and each downlink transmission may include one or more RLC SDUs (e.g., a PPDU that includes one or more RLC SDUs). Each RLC SDU may have or be associated with a corresponding SN, and a set of the RLC SDUs may be grouped together. The UE 115 may store the RLC SDUs in a buffer until an entire group (e.g., sequence) of the RLC SDUs are received, as described with reference to FIG. 3.

At 615, the UE 115 may optionally transmit one or more acknowledgement transmissions for the downlink transmissions from the base station 105. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of a reassembly timer.

At 620, the UE 115 determines to start a reassembly timer based on the transmissions from a base station 105. For example, the UE 115 may determine a “hole” or “gap” in received RLC SDUs, or a sequence or group thereof, based on SNs of the received RLC SDU. The UE 115 may then start the reassembly timer for one or more of the RLC SDUs, and corresponding SNs. The UE 115 may set the reassembly timer to a duration indicated by the reassembly timer configuration information from the network and determine an original or network configured reassembly timer duration and expiration time.

At 625, the UE 115 performs dynamic reassembly timer operations. For example, the UE 115 may perform AI/ML analysis on whether the missing RLC SDUs of the group or sequence will be received within the original or network configured reassembly timer duration and prior to the original or network configured expiration time. To illustrate, the UE 115 may utilize the reassembly timer adjuster 416 to perform AI/ML operations using the AI/ML model information and based on the input parameters described with reference to FIG. 4 and optionally any UE or network imposed constraints, such as those described with reference to FIGS. 4 and 9 (e.g., min. or max. duration values). The UE 115 (e.g., the reassembly timer adjuster 416 thereof) may output one or more parameters regarding the reassembly timer operations. For example, the reassembly timer adjuster 416 may output a prediction of whether the reassembly timer operation will succeed or fail and a probability or confidence value of its prediction. As another example, the reassembly timer adjuster 416 may output an indication to stop the reassembly timer at a particular time or to adjust the reassembly timer duration or time remaining by a particular amount, such as to end the reassembly timer at some point in the future and if the RLC SDUs are not received by then.

At 630, the UE 115 determines to dynamically update the reassembly timer and to adjust the reassembly timer prior to expiration. For example, the UE 115 determines to dynamically update the reassembly timer based on the output or outputs from the AI/ML evaluation of whether the outstanding or missing RLC SDUs will be received within the original or network configuration expiration time. The UE 115 may dynamically adjust the reassembly timer by reducing or increasing a duration of the reassembly timer from the original or network configuration expiration time.

When dynamically adjusting the reassembly timer, the UE 115 may utilize parameters from the network. For example, the reassembly timer configuration information received from the base station 105 may indicate one or more parameters that guides or bounds how the UE 115 may adjust the reassembly timer. To illustrate, the reassembly timer configuration information may indicate one or more adjust parameters of a minimum reassembly timer duration, a maximum reassembly timer duration, a reassembly timer stop prohibit interval value, a minimum reassembly timer adjustment value, a maximum reassembly timer adjustment value, a reassembly timer prediction error backoff value, a reassembly timer performance target metric, or a combination thereof. Additionally, or alternatively, the reassembly timer configuration information may indicate whether or not AI/ML based dynamic adjustment of the reassembly timer is permitted or not. An example of reassembly timer configuration information is provided in FIG. 9.

The minimum reassembly timer duration and the maximum reassembly timer duration may act as boundary conditions for adjusting the reassembly timer, that is what the adjusted value is. In some implementations, the maximum reassembly timer may act as a baseline, default, or fallback value, such as in implementations where a UE is not allowed to extend the reassembly timer. The minimum reassembly timer adjustment value and the maximum reassembly timer adjustment value may act as boundary conditions for adjustment amounts to the reassembly timer for a single cycle or reassembly timer.

The reassembly timer stop prohibit interval value may be used for early termination of the reassembly timer, and may represent a minimum amount of time the UE must wait between two successive reassembly timer early termination decisions. The reassembly timer prediction error backoff value may correspond to a duration (e.g., waiting time or a backoff time) before applying AI/ML operations or parameters again after an error in AI/ML operations or parameters. For example, the UE may use the reassembly timer prediction error backoff value when the UE makes a prediction error (e.g., stops t-reassembly too early in RLC UM) and the reassembly timer duration is reset to configured fallback behavior (e.g., max-t-Reassembly).

The performance target metric limit may include limitations on or for underpredictions and/or duplicated transmissions. Duplicated transmissions may be caused by a UE setting the reassembly timer too low, and consistent and/or severe underprediction may cause excessive duplicated transmissions, such as lost premature retransmissions. Additionally, or alternatively, the performance target metric limit may include limitations on or for overpredictions and/or excess delays/latency and memory usage. For example, end-to-end (E2E) latency, adjusted timer success rate, adjusted timer failure rate, memory usage, available memory, and other KPIs may be used as performance target metrics.

At 635, the UE 115 transmits a reassembly timer dynamic update indication. For example, the UE 115 transmits a reassembly timer dynamic update to the base station 105 to indicate that the UE 115 has determined to adjust the reassembly timer from the network configured duration. In some implementations, the UE 115 transmits an indication of how much the UE 115 adjusted the reassembly timer, how much time was remaining on the reassembly timer when it was ended early, the confidence value or probability the UE 115 determined for the adjustment, or a combination thereof. In some such implementations, an amount of time indicated by the UE 115 may correspond to a quantized amount. For example, the amount of time the reassembly timer was adjusted or the amount of time remaining on the reassembly timer when stopped early may be rounded to a nearest whole number, such as X ms or X cycles.

The reassembly timer dynamic update indication may be sent in a RLC control message, a MAC CE, in UE assistance information, or in a periodic RRC message. For example, the RLC control message may include or correspond to a new RLC control message, such as a new RLC control message format. As an illustrative example a new field may be added to a STATUS PDU message or an existing field may be repurposed in certain instances. Similarly, the MAC CE may include or correspond to a new MAC CE message, such as a new MAC CE format. Regarding the periodic RRC message, the periodic RRC message may include or correspond to a new periodic RRC message, such as a periodic RRC message that updates the network with new User Plane AI/ML native parameters, such as new MAC layer, RLC layer, and/or PDCP parameters.

The UE 115 may then proceed with conventional operations performed after expiration of a reassembly timer responsive to the UE 115 adjusting the reassembly timer or after it notifies the network to adjust reassembly timer. For example, the UE 115 may engage in PDCP layer operations (e.g., PDCP reordering), memory flushing operations, HARQ feedback operations, etc.

After 635, the UE 115 optionally transmits one or more acknowledgement transmissions based on the reassembly timer dynamic update indication. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of a reassembly timer.

At 640, the base station 105 optionally determines to update one or more reassembly timer parameters based on the reassembly timer dynamic update indication. For example, the base station 105 determines to update reassembly timer parameters based on receiving the reassembly timer dynamic update indication from the UE 115. The reassembly timer parameters may include the reassembly timer duration, a reassembly timer duration adjustment amount, reassembly timer duration adjustment parameters, reassembly timer early termination parameters, or a combination thereof. To illustrate, the base station 105 determines to update a remaining duration of a current reassembly timer for the UE 115 (e.g., an active reassembly timer for RLC SDUs of the one or more downlink transmissions) and optionally to adjust a future starting duration for reassembly timer(s) for the UE 115 based on receiving the reassembly timer dynamic update indication from the UE 115

After 645, the base station 105 optionally transmits a reassembly timer dynamic update acknowledgement transmission based on the reassembly timer dynamic update indication. For example, the base station 105 transmits a reassembly timer dynamic update acknowledgement indication responsive to the received reassembly timer dynamic update indication from the UE 115.

After 645, the base station 105 optionally retransmits one or more downlink transmissions based on the reassembly timer dynamic update indication. For example, the base station 105 may determine to retransmit one or more RLC SDUs to the UE 115 based on the received reassembly timer dynamic update indication from the UE 115 at 650. To illustrate, the base station 105 may determine to adjust or may adjust the reassembly timer based on the reassembly timer dynamic update indication, and the base station 105 may transmit retransmits one or more downlink transmissions responsive to expiration of the adjusted reassembly timer and/or responsive to receipt of feedback information for the one or more downlink transmissions after expiration of the adjusted reassembly timer.

At 655, the UE 115 may optionally transmit one or more acknowledgement transmissions for the retransmitted downlink transmissions from the base station 105 at 650. For example, when the UE 115 is operating in an AM, the UE 115 may transmit feedback information (e.g., HARQ-ACK information) in PUSCH or PUCCH transmission for the received retransmitted PDSCHs from the base station 105 responsive to receiving a sequence of RLC SDUs and/or responsive to expiration of a reassembly timer.

Referring to FIG. 7, dynamic reassembly timer update request operations are illustrated for enhanced dynamic reassembly timer operations. For example, in FIG. 7, a device performs dynamic reassembly timer evaluation operations and determines to request a dynamic adjustment or update to the reassembly timer. In the example of FIG. 7, the device may receive information for setting the reassembly timer from the network, determine to start the reassembly timer based on downlink data transmissions from the network, and determine to transmit an update request for the reassembly timer based on performing AI/ML analysis on the channel, the received SDUs, and the performance history. Requesting a dynamic adjustment of the reassembly timer by the device may enable the device to extend the reassembly timer to enable the RLC SDUs to be received in time, and thus prevent RLC recovery operations for small extensions of the reassembly timer. Additionally, requesting a dynamic adjustment of the reassembly timer by the device may enable the device to release the SDUs early which reduces memory usage, reduces excessive and unnecessary delay/latency, and may initiate feedback procedures (e.g., in AM operations). Reducing the memory may help facilitate transmission bursts with less memory and/or enable larger transmission bursts.

As compared to the example of FIG. 5 where the device indicates early termination or expiration and the example of FIG. 6 where the device indicates an adjustment to the reassembly timer, the example of FIG. 7 provides a dynamic reassembly timer update request to the network, and the network actually adjusts the reassembly timer. The dynamic reassembly timer update request and/or update may indicate a new reassembly timer duration or expiration, or a new parameters for dynamic reassembly timer operations.

In the example of FIG. 7, the devices may engage in downlink and uplink transmissions. Prior to the operations illustrated in FIG. 7, the UE 115 receives reassembly timer configuration information, such as described with reference to FIG. 4. For example, the UE 115 may receive a configuration transmission or a transmission upon connection or setup which includes reassembly timer configuration information, and which indicates a default or base reassembly timer duration, such as configuration transmission 450 including reassembly timer settings data 446.

During operations, the UE 115 receives downlink transmissions from a base station 105 at 710. For example, the UE 115 may receive one or more downlink transmissions, and each downlink transmission may include one or more RLC SDUs (e.g., a PPDU that includes one or more RLC SDUs). Each RLC SDU may have or be associated with a corresponding SN, and a set of the RLC SDUs may be grouped together. The UE 115 may store the RLC SDUs in a buffer until an entire group (e.g., sequence) of the RLC SDUs are received, as described with reference to FIG. 3.

At 715, the UE 115 may optionally transmit one or more acknowledgement transmissions for the downlink transmissions from the base station 105. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of a reassembly timer.

At 720, the UE 115 determines to start a reassembly timer based on the transmissions from a base station 105. For example, the UE 115 may determine a “hole” or “gap” in received RLC SDUs, or a sequence or group thereof, based on SNs of the received RLC SDU. The UE 115 may then start the reassembly timer for one or more of the RLC SDUs, and corresponding SNs. The UE 115 may set the reassembly timer to a duration indicated by the reassembly timer configuration information from the network and determine an original or network configured reassembly timer duration and expiration time.

At 725, the UE 115 performs dynamic reassembly timer operations. For example, the UE 115 may perform AI/ML analysis on whether the missing RLC SDUs of the group or sequence will be received within the original or network configured reassembly timer duration and prior to the original or network configured expiration time. To illustrate, the UE 115 may utilize the reassembly timer adjuster 416 to perform AI/ML operations using the AI/ML model information and based on the input parameters described with reference to FIG. 4 and optionally any UE or network imposed constraints, such as those described with reference to FIGS. 4 and 9 (e.g., min. or max. duration values). The UE 115 (e.g., the reassembly timer adjuster 416 thereof) may output one or more parameters regarding the reassembly timer operations. For example, the reassembly timer adjuster 416 may output a prediction of whether the reassembly timer operation will succeed or fail and a probability or confidence value of its prediction. As another example, the reassembly timer adjuster 416 may output an indication requesting permission to stop the reassembly timer at a particular time or to adjust the reassembly timer duration or time remaining by a particular amount, such as to end the reassembly timer at some point in the future and if the RLC SDUs are not received by then.

At 730, the UE 115 determines to request a dynamic update for the reassembly timer. For example, the UE 115 determines to a performance improvement may be obtained by dynamically updating the currently running reassembly timer, updating a future reassembly timer(s), or updating a reassembly timer parameter for the current and/or future reassembly timers based on the output or outputs from the AI/ML evaluation of whether the outstanding or missing RLC SDUs will be received within the original or network configuration expiration time. The UE 115 may initiate or cause the network to adjust the reassembly timer operations.

At 735, the UE 115 transmits a reassembly timer dynamic update indication. For example, the UE 115 transmits a reassembly timer dynamic update request indication to the base station 105 to indicate that the UE 115 has determined to adjust the reassembly timer from the network configured duration. In some implementations, the UE 115 transmits an indication of how much the UE 115 adjusted the reassembly timer, how much time was remaining on the reassembly timer when it was ended early, the confidence value or probability the UE 115 determined for the adjustment, or a combination thereof. In some such implementations, an amount of time indicated by the UE 115 may correspond to a quantized amount. For example, the amount of time the reassembly timer was adjusted or the amount of time remaining on the reassembly timer when stopped early may be rounded to a nearest whole number, such as X ms or X cycles.

The reassembly timer dynamic update indication may be sent in a RLC control message, a MAC CE, in UE assistance information, or in a periodic RRC message. For example, the RLC control message may include or correspond to a new RLC control message, such as a new RLC control message format. As an illustrative example a new field may be added to a STATUS PDU message, or an existing field may be repurposed in certain instances. Similarly, the MAC CE may include or correspond to a new MAC CE message, such as a new MAC CE format. Regarding the periodic RRC message, the periodic RRC message may include or correspond to a new periodic RRC message, such as a periodic RRC message that updates the network with new User Plane AI/ML native parameters, such as new MAC layer, RLC layer, and/or PDCP parameters.

At 740, the base station 105 determines to dynamically update the reassembly timer and to adjust the reassembly timer prior to expiration based on receiving the reassembly timer dynamic update indication. For example, the base station 105 determines to dynamically update the reassembly timer based on the output or outputs from the AI/ML evaluation performed by the UE 115 and included in or indicated by the reassembly timer dynamic update indication from the UE 115. The base station 105 may dynamically adjust the reassembly timer based on receiving the reassembly timer dynamic update indication alone, or additionally based on performing one or more determinations at the network. For example, the base station 105 may also perform AI/ML operations for dynamically updating the reassembly timer. To illustrate, the base station 105 may reduce or increase a duration of the reassembly timer from the original or network configuration expiration time and/or adjust a reassembly timer parameter based on probability information and latency information from the UE 115.

When dynamically adjusting the reassembly timer, the base station 105 may utilize information from the AI/ML evaluation by the UE 115 and reassembly timer parameter or configuration information. For example, the reassembly timer configuration information may indicate one or more parameters that guides or bounds how the UE 115 and/or base station 105 may adjust the reassembly timer. To illustrate, the reassembly timer configuration information may indicate one or more adjust parameters of a minimum reassembly timer duration, a maximum reassembly timer duration, a reassembly timer stop prohibit interval value, a minimum reassembly timer adjustment value, a maximum reassembly timer adjustment value, a reassembly timer prediction error backoff value, a reassembly timer performance target metric, or a combination thereof. Additionally, or alternatively, the reassembly timer configuration information may indicate whether or not AI/ML based dynamic adjustment of the reassembly timer is permitted or not. An example of reassembly timer configuration information is provided in FIG. 9.

At 745, the base station 105 transmits a reassembly timer dynamic update transmission based on the reassembly timer dynamic update indication. For example, the base station 105 transmits a reassembly timer dynamic update acknowledgement or confirmation indication or responsive to the received reassembly timer dynamic update request from the UE 115. To illustrate, the base station 105 may confirm or accept a particular reassembly timer update request from the UE 115, such as end the reassembly timer early, shorten the reassembly timer duration, or adjust a reassembly timer parameter for future operations. Alternatively, the base station 105 may reject the update from the UE 115 based on performance of a network determination (e.g., AI/ML determination) based on the request from the UE 115 and based on request from one or more other UEs. In such implementation, the update request from UE 115 indicates a particular reassembly timer change, in addition to or in the alternative of, reassembly timer probability and latency information.

As another example, the base station 105 transmits a reassembly timer dynamic update indication (e.g., change or adjustment indication) responsive to the received reassembly timer dynamic update request from the UE 115. To illustrate, the base station 105 may instruct the UE 115 to change a current reassembly timer or change or adjust a reassembly timer parameter for future operations based on the UE providing reassembly timer probability and latency information from its AI/ML operations. In some such implementations, the UE 115 may not provide a specific change request (e.g., reduce current reassembly timer duration by 20 ms, stop current reassembly timer early, or adjust reassembly timer duration for future reassembly timers by 10 ms). Additionally, or alternatively, the UE 115 may include or indicate a particular reassembly timer change in the reassembly timer dynamic update request, and the base station 105 may determine to not use the particular change or to make a different changes based on the other information received.

At 750, the UE 115 optionally transmits a reassembly timer dynamic update acknowledgement transmission based on the reassembly timer dynamic update transmission. For example, when the UE 115 may confirm receipt of the reassembly timer dynamic update transmission and corresponding reassembly timer dynamic update indicated therein. The UE 115 adjusts the reassembly timer or parameters thereof responsive to receiving the reassembly timer dynamic update transmission.

After 745, the UE 115 optionally transmits one or more acknowledgement transmissions based on the reassembly timer dynamic update transmission. For example, when the UE 115 is operating in an AM, the UE 115 may transmit feedback information (e.g., HARQ-ACK information) in PUSCH or PUCCH transmission for the received PDSCHs from the base station 105 responsive to receiving a sequence of RLC SDUs and/or responsive to expiration of the adjusted reassembly timer operations indicated by the reassembly timer dynamic update transmission.

The UE 115 may then proceed with conventional operations performed after expiration of a reassembly timer responsive to the UE 115 adjusting the reassembly timer or after it notifies the network to adjust reassembly timer. For example, the UE 115 may engage in PDCP layer operations (e.g., PDCP reordering), memory flushing operations, HARQ feedback operations, etc.

At 755, the UE 115 optionally transmits AI/ML model update information. For example, the UE 115 may transmit AI/ML model update information to the base station 105 periodically, or responsive to a trigger or determination. In some implementations, the network may request the update, and pull the information from the UE 115. In other examples, the UE 115 may transmit the AI/ML model information to another device, such as another network device or a device on another network. To illustrate, the AI/ML model information may be stored at and controlled by a dedicated server separate from the network and base station 105.

The UE 115 may transmit reassembly timer log information to the network for use in updating the AI/ML model. For example, the UE 115 may log reassembly timer expiration statistics, such as number of occurrences, corresponding duration for the occurrences, etc. Additionally, or alternatively, the UE 115 may log latency information to receive a RLC SN SDU after transmitting a status PDU. The UE 115 may provide this latency information to the network. The latency information may be provided as or to illustrate a distribution of latencies and the latency from the status PDU to reception may indicate excess reassembly timer duration. In some implementations, such as for UM operations, the UE 115 may log RLC SNs that were received after the UE gave up, which may indicate stopping the reassembly timer too early.

Additionally, or alternatively, the UE 115 may transmit performance of the reassembly timer predictions generated by the UE 115, such as the outputs of the AI/ML model. For example, the UE 115 may flag errors during reassembly timer update operations and transmit information indicating the errors (e.g., over prediction, under prediction, etc.). The error information may include amount of occurrences, severity of the occurrence, etc. The UE 115 may further indicate the corresponding prediction related with the occurrence and/or how to occurrence was handled, e.g., fallback, readjustment, etc.

The UE 115 may transmit other information related to or used by the AI/ML model, such as logs for the input parameters to the AI/ML model and the corresponding outputs generated (e.g., predictions made) based on the input parameters. For example, the UE 115 may log and transmit model input information for an amount of retransmissions, an amount PRBs used, a MIMO configuration of the transmissions, an MCS of the transmission, PHY layer parameters, a transport block size, channel quality metrics, HARQ RTT, etc., or any combination thereof.

At 760, the base station 105 optionally transmits AI/ML model update information. For example, the base station 105 may transmit AI/ML model update information to the UE 115 periodically, or responsive to a trigger or determination. In some implementations, the UE 115 may request the update, and pull the information from the network. In other examples, the UE 115 may receive the AI/ML model information from another device, such as another network device or a device on another network.

After 750, the base station 105 optionally retransmits one or more downlink transmissions based on the reassembly timer dynamic update transmission, similar to as described with reference to FIGS. 5 and 6. For example, the base station 105 may determine to retransmit one or more RLC SDUs to the UE 115 based on the received reassembly timer dynamic update transmission to the UE 115 at 745, similar to the operations described at 550 of FIGS. 5 and 650 of FIG. 6. Additionally, the UE 115 may optionally transmit one or more acknowledgement transmissions for the retransmitted downlink transmissions from the base station 105, similar to the operations described at 555 of FIGS. 5 and 655 of FIG. 6. For example, when the UE 115 is operating in an AM, the UE 115 may transmit feedback information (e.g., HARQ-ACK information) in PUSCH or PUCCH transmission for the received retransmitted PDSCHs from the base station 105 responsive to receiving a sequence of RLC SDUs and/or responsive to expiration of a reassembly timer.

Although the UE 115 is illustrated as transmitting the AI/ML model update to the base station 105 at 750 in the example of FIG. 7, the UE 115 may transmit the AI/ML model update information to the base station 105 for transmission (retranmission or relay) to a separate AI/ML server or database. Alternativelyl, in other implemetnations, the UE 115 may transmit the AI/ML model update information to a different base station or intermediary device or directly to the AI/ML server or database (e.g., through a Wi-Fi connection).

FIG. 8 is a diagram 800 illustrating an example of a status report message according to one some aspects of the present disclosure. In the example of FIG. 8, the status report message include an early termination indication. Additionally, or alternatively, the status report message may include a reassembly timer dynamic update indication, a reassembly timer dynamic update request indication, reassembly timer dynamic update information, or a combination thereof.

The status report message may include information for multiples RLC SDUs. As illustrated in the example of FIG. 8, the status report message includes status information for three RLC SDUs, that is RLC SDUs with the sequence numbers of 21, 13, and 18. The device is reporting a received or acknowledged status for SN 21 and a not received or unacknowledged status for SNs 13 and 18.

In the example of FIG. 8, the status report message includes an early termination indication in the eighth bit of the status information for the last RLC SDU, designated by the bit denomination of ES. In other implementations, the early termination indication may be a different bit, such as another reserve bit, designated as R in FIG. 8, or may be part of a larger field. For example, a two-bit or larger field may have bit values which can indicate multiple indications, one of which is a bit value (e.g., 01) that indicates early termination of the reassembly timer.

Optionally, and as illustrated in the example of FIG. 8, the status report message may include additional bits (here two bytes) indicating reassembly timer dynamic update information. In the example of FIG. 8, the status report message includes indicating reassembly timer dynamic update information indicating the amount of time remaining on the reassembly timer when the device performed its early termination of the reassembly timer. For example, if 200 ms remained on the reassembly timer when it was stopped, the field may indicate 200 ms. As another example the device may quantize or convert the timer into another duration or measurement, such as convert 200 ms in X amount of cycles, or convert (e.g., quantize or round) 199.5 or 202 ms to 200 ms.

The status report message may include or correspond to a modified STATUS PDU sent responsive to a polling message or indication from the network. For example, the status report message may have a similar format to a conventional status PDUs sent responsive to polling bits. To illustrate, the status report message may have a format, layout and length that corresponds to current status PDU formats. The status report message may have additional indications and/or information, and as illustrated in FIG. 8, the status report message may provide the indications and/or information using currently unused/reserve bits and/or by adding additional bits.

FIG. 9 is a diagram 900 illustrating an example of enhanced dynamic reassembly timer configuration information according to some aspects of the present disclosure. In the example of FIG. 9, the enhanced dynamic reassembly timer configuration information is included in or is a part of RLC configuration information, which itself may be part of RRC configurations. The enhanced dynamic reassembly timer configuration information includes one or more network constraints that a network may utilize to guide UE-based AI/ML operations.

Different types of status reporting may be used by devices for reassembly timer dynamic updates. For example, devices may use differential or compressed status reporting when a device sets the reassembly timer to a value lower than a currently configured threshold. For example, the device may use a compressed format to indicate the change with less bits, such as a bit value of 0 indicating a 10 ms change and a bit value of 1 indicating a 100 ms change. As another example, the device may indicate a difference between the recommended or determined duration and the current duration (e.g., 11 ms difference between 110 ms and 121 ms) as opposed to indicating the changed value (e.g., 110 ms).

As described with reference to FIG. 4 above, the minimum and maximum reassembly timer values may be used by UEs as boundary conditions for the duration of the reassembly timer to limit over and under predictions. In some implementations, the maximum reassembly timer values may be used as a base duration and/or a fallback duration for the reassembly timer. The reassembly timer stop prohibit interval value may be used for early termination of the reassembly timer, and may represent a minimum amount of time the UE must wait between two successive reassembly timer early termination decisions. The reassembly timer prediction error backoff value may correspond to a duration (e.g., waiting time or a backoff time) before applying AI/ML operations or parameters again after an error in AI/ML operations or parameters. For example, the UE may use the reassembly timer prediction error backoff value when the UE makes a prediction error (e.g., stops t-reassembly too early in RLC UM) and the reassembly timer duration is reset to configured fallback behavior (e.g., max-t-Reassembly).

The AI/ML allowed parameter is an indication of whether the network allows or enables enhanced AI/ML based operations, or which types of operations, for dynamic reassembly timer update operations. The QoS flow parameter indicates which QoS flow or flows are eligible for the AI/ML operations, or specific types, when AI/ML operations are allowed by the AI/ML allowed parameter.

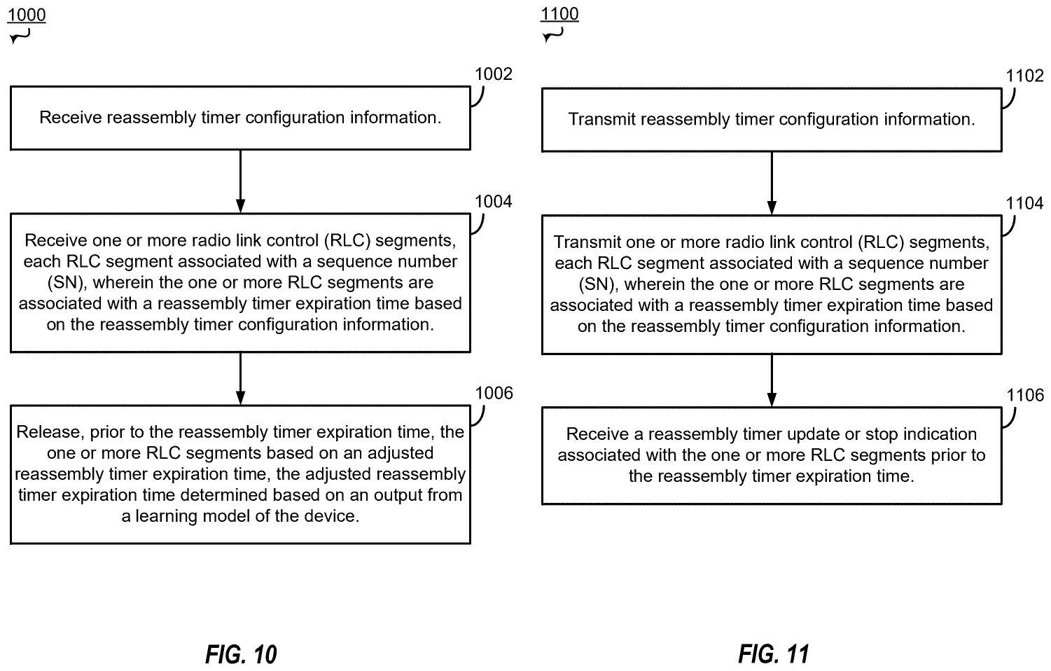

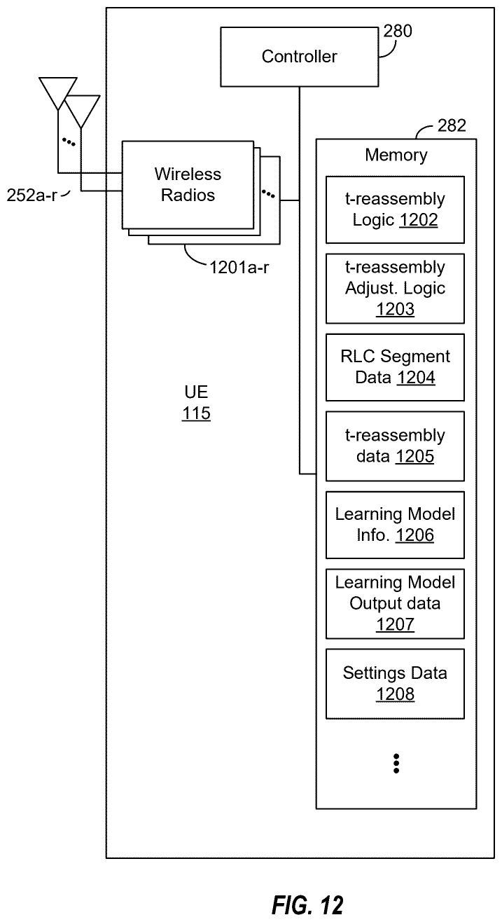

FIG. 10 is a flow diagram 1000 illustrating example blocks executed by a UE configured according to an aspect of the present disclosure. The example blocks will also be described with respect to UE 115 as illustrated in FIG. 12. FIG. 12 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1200a-r and antennas 252a-r. Wireless radios 1200a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 12, memory 282 stores reassembly timer logic 1202, reassembly timer adjustment logic 1203, RLC segment data 1204, reassembly timer data 1205, learning model information 1206, learning model output data 1207, and settings data 1208.

At block 1002, a wireless communication device, such as a UE, receives reassembly timer configuration information. For example, the reassembly timer configuration information may include or correspond to one or more of the reassembly timer data 406, the reassembly timer adjustment data 408, the reassembly timer AI/ML model data 444, or the reassembly timer settings data 446 of FIG. 4. To illustrate, the UE 115 receives the reassembly timer settings data 446 in the configuration transmission 450 from the network entity 405, as described with reference to FIG. 4.

At block 1004, the UE 115 receives one or more radio link control (RLC) segments, each RLC segment associated with a sequence number (SN), wherein the one or more RLC segments are associated with a reassembly timer expiration time based on the reassembly timer configuration information. For example, the one or more RLC segments may include or correspond to any of the RLC segments of downlink transmissions described with reference to FIGS. 4-7, such as the first RLC SDUs 452 (e.g., any SDU segment or segments thereof) and/or the second RLC SDUs 454 of FIG. 4 (e.g., any SDU segment or segments thereof). The one or more RLC segments may also include or correspond to the RLC segment data 442 of FIG. 4, where they are associated with a SN or SNs and with a reassembly timer or a reassembly timer expiration value, such as in the reassembly timer data 406. To illustrate, the UE 115 receives the first RLC SDUs 452 and/or the second RLC SDUs 454 of FIG. 4 in downlink transmissions PDSCHs) from the network entity 405, as described with reference to FIG. 4.

At block 1006, the UE 115 releases, prior to the reassembly timer expiration time, the one or more RLC segments based on an adjusted reassembly timer expiration time. The adjusted reassembly timer expiration time is determined based on an output from a learning model of the device. For example, the adjusted reassembly timer expiration time may include or correspond to the reassembly timer data 406 and/or the reassembly timer adjustment data 408 of FIG. 4. To illustrate, the UE 115, such as the reassembly timer adjuster 416 thereof, may perform AI/ML operations to determine an adjusted reassembly timer expiration value for the one or more RLC segments based on the original reassembly timer or expiration value, as described with reference to FIG. 4. As an illustrative, example, the reassembly timer adjuster 416 utilizes a learning model, such as the reassembly timer AI/ML model data 444, to determine one or more outputs either indicating the adjusted reassembly timer expiration value or to be used determining the adjusted reassembly timer expiration value, such as a probability value output and/or an expected latency output. The UE 115 may then determine to release the one or more RLC segments based on the adjusted reassembly timer expiration value, such as described with reference to any of FIGS. 4-7. For example, the UE 115 may decide to perform early termination based on the adjusted reassembly timer expiration time, as in FIG. 5, to dynamically change the reassembly timer or parameters as in FIG. 6, or the request a reassembly timer or parameter change as in FIG. 7. Termination of the reassembly timer may include informing other layers of the reassembly timer expiration, releasing RLC SDUs stored in memory, transmitting a release indication to the network, etc., or any combination thereof.

The UE 115 may execute additional blocks (or the UE 115 may be configured further perform additional operations) in other implementations. For example, the UE 115 may perform one or more operations described above, one or more aspects as described below, or a combination thereof.

In a first aspect, a device for wireless communication includes at least one processor; and a memory coupled to the at least one processor. The at least one processor is configured to cause the device to: receive reassembly timer configuration information; receive one or more radio link control (RLC) segments, each RLC segment associated with a sequence number (SN), wherein the one or more RLC segments are associated with a reassembly timer expiration time based on the reassembly timer configuration information; and release, prior to the reassembly timer expiration time, the one or more RLC segments based on an adjusted reassembly timer expiration time, the adjusted reassembly timer expiration time determined based on an output from a learning model of the device.

In a second aspect, alone or in combination with one or more of the above aspects, the at least one processor is further configured to cause the device to: transmit a status report to network indicating early termination responsive to expiration of the adjusted reassembly timer expiration time.

In a third aspect, alone or in combination with one or more of the above aspects, the status report includes an early termination flag bit (e.g., single bit, such as ES BIT).

In a fourth aspect, alone or in combination with one or more of the above aspects, the status report further indicates an amount of time the reassembly timer expiration time was adjusted or an amount of time remaining on the reassembly timer when adjusted.

In a fifth aspect, alone or in combination with one or more of the above aspects, the status report further includes a quantized amount (e.g., rounded or adjusted amount) of time that indicates how much time was remaining on the reassembly timer at early termination.

In a sixth aspect, alone or in combination with one or more of the above aspects, the at least one processor is further configured to cause the device to: transmit a reassembly timer stop polling bit indicating that the device has stopped the reassembly timer early (e.g., prior to the network configured time), responsive to expiration of the adjusted reassembly timer expiration time.

In a seventh aspect, alone or in combination with one or more of the above aspects, the configuration information indicates a network configured reassembly timer duration and whether artificial intelligence (AI) or machine learning (ML) behavior is permitted for reassembly timer adjustment operations.

In an eighth aspect, alone or in combination with one or more of the above aspects, the configuration information indicates a minimum reassembly timer duration, a maximum reassembly timer duration, a reassembly timer stop prohibit interval value, a reassembly timer prediction error backoff value, a reassembly timer performance target metric, or a combination thereof, and wherein the a reassembly timer performance target metric includes an underprediction metric, an overprediction metric, an end-to-end (E2E) latency metric, a retransmission metric, or a combination thereof.

In a ninth aspect, alone or in combination with one or more of the above aspects, the at least one processor is further configured to cause the device to: determine, using an AI or ML model, a probability distribution value indicating when a particular SN of the SNs will be completely received and the likelihood of whether the particular SN will not be received before expiration of the reassembly timer. In other aspects, the probability distribution value and/or likelihood value may be per RLC SDU or segment thereof.

In a tenth aspect, alone or in combination with one or more of the above aspects, the at least one processor is further configured to cause the device to: determine, using the AI or ML model, an expected latency of the particular RLC segment and whether a latency for the particular RLC segment will extend beyond expiration of the reassembly timer, a packet delay budget threshold, or both.

In an eleventh aspect, alone or in combination with one or more of the above aspects, the at least one processor is further configured to cause the device to: determine whether the probability distribution value satisfies a probability distribution value threshold; determine, based on a determination that the probability distribution value satisfies the probability distribution value threshold, whether the expected latency of the particular RLC segment will extend beyond the expiration of the reassembly timer expiration time; and determine to adjust the reassembly timer expiration time based on a determination that the expected latency of the particular RLC segment will extend beyond the expiration of the reassembly timer.

In a twelfth aspect, alone or in combination with one or more of the above aspects, the at least one processor is further configured to cause the device to: determine the adjusted reassembly timer expiration time based on the expected latency of the particular RLC segment and the probability distribution value; and adjust the reassembly timer expiration time to the adjusted reassembly timer expiration time based on a comparison of a performance metric of the learning model to an underprediction metric, an overprediction metric, or both, wherein the overprediction metric is determined based on a duplicated transmission metric.

In a thirteenth aspect, alone or in combination with one or more of the above aspects, the at least one processor is further configured to cause the device to: determine to not adjust the reassembly timer expiration time based on: a determination that the probability distribution value does not satisfy the probability distribution value threshold; or a determination that the expected latency of the particular RLC segment will not extend beyond the expiration of the reassembly timer.

In a fourteenth aspect, alone or in combination with one or more of the above aspects, the at least one processor is further configured to cause the device to: determine the reassembly timer expiration time for the one or more RLC segments based on the associated SNs and the reassembly timer configuration information; and adjust the reassembly timer expiration time to the adjusted reassembly timer expiration time based on a determination by the learning model (e.g., AI/ML Model) of the device.

In a fifteenth aspect, alone or in combination with one or more of the above aspects, the at least one processor is further configured to cause the device to: store actual RLC latency data, estimated latency data of RLC segments, estimated reassembly timer values, learning model input data, learning model performance data, or a combination thereof, in as reassembly timer log data; and transmit the reassembly timer log data to the network or to an AI/ML server.

In a sixteenth aspect, alone or in combination with one or more of the above aspects, the at least one processor is further configured to cause the device to: receive a learning model indication and optionally updated learning model information responsive to transmission of the reassembly timer log data, wherein the learning model indication is configured to indicate a learning model update, to activate a particular learning model, to deactivate a particular learning model, or to switch between particular learning models.

In a seventeenth aspect, alone or in combination with one or more of the above aspects, the at least one processor is further configured to cause the device to: transmit reassembly timer reporting capability information to the network or to a learning server, the reassembly timer reporting capability information indicating a capability to report one or more of RLC level data, LCH level data, user plan level data, protocol level data, parameter level data, or learning model output type data.

In an eighteenth aspect, alone or in combination with one or more of the above aspects, the processor configured to cause the device to determine the reassembly timer expiration time for the one or more RLC segments based on the associated SNs and the reassembly timer configuration information includes to: start a reassembly timer for a particular RLC segment of the one or more RLC segments responsive to detection of a missed RLC segment of the one or more RLC segments based on the associated SNs of the one or more RLC segments and the reassembly timer configuration information, the reassembly timer set based on a reassembly timer expiration duration (e.g., base, default, and/or minimum duration) indicated in the reassembly timer configuration information.

In a nineteenth aspect, alone or in combination with one or more of the above aspects, the at least one processor is further configured to cause the device to: detect the missed RLC segment, wherein to detect the RLC segment includes to: determine a SN for each RLC segment of the one or more RLC segments; determine a particular sequence based on the determined SNs; and determine a gap in the particular sequence for the received one or more RLC segments indicating a not yet received RLC segment.

In a twentieth aspect, alone or in combination with the nineteenth aspect, the at least one processor configured to cause the device to adjust the reassembly timer expiration time includes to: determine the adjusted reassembly timer expiration time for the one or more RLC segments using the learning model and one or more inputs, wherein the one or more inputs include an amount of retransmissions, an amount of PRBs used, a MIMO configuration of the transmissions, MCS information, PHY layer parameter information, a Transport block size, channel quality information, or HARQ RTT.

In a twenty-first aspect, alone or in combination with one or more of the above aspects, the at least one processor configured to cause the device to adjust the reassembly timer expiration time includes to: determine the adjusted reassembly timer expiration time for the one or more RLC segments using the learning model, one or more inputs, and one or more constraints, wherein the one or more constraints include a network configured maximum reassembly timer duration, a network configured minimum reassembly timer duration, a network configured maximum reassembly timer adjustment value, a network configured minimum reassembly timer adjustment value, a fallback reassembly timer value, or fallback behavior information.

In a twenty-second aspect, alone or in combination with one or more of the above aspects, the at least one processor configured to cause the device to adjust the reassembly timer expiration time includes to: determine to adjust the reassembly timer expiration time for the one or more RLC segments based on the learning model; transmit a reassembly timer update request to the network, the reassembly timer update request includes one or more recommended reassembly timer parameter values, reassembly timer learning model prediction information, or both; and receive, responsive to the reassembly timer update request, a reassembly timer update response from the network indicating the adjusted reassembly timer expiration time.

In a twenty-third aspect, alone or in combination with one or more of the above aspects, the at least one processor is further configured to cause the device to: send, by an RLC layer to a PDCP layer, a reassembly timer update notification indicating an estimated latency of the one or more RLC segments; and determine, by the PDCP layer, an update value for PDCP reordering operations based on the reassembly timer update notification and the estimated latency.

In a twenty-fourth, alone or in combination with one or more of the above aspects, the at least one processor is further configured to cause the device to: transmit, based on the adjusted reassembly timer expiration time, a HARQ feedback transmission indicating feedback information for the one or more RLC segments; and receive one or more retransmissions for the one or more RLC segments based on the HARQ feedback transmission.

In a twenty-fifth aspect, alone or in combination with one or more of the above aspects, the device is operating in an acknowledge mode (AM) RLC mode, and wherein the device is configured to wait for expiration of the reassembly timer before reporting acknowledgement information (e.g., ACK/NACK) of the one or more RLC segments.

In a twenty-sixth aspect, alone or in combination with one or more of the above aspects, the device is operating in an unacknowledged mode (UM) RLC mode, and wherein the device is configured to wait for expiration of the reassembly timer before discarding the one or more RLC segments.

In an additional aspect, a device for wireless communication includes: at least one processor; and a memory coupled to the at least one processor. The at least one processor is configured to cause the device to: receive reassembly timer configuration information; receive one or more radio link control (RLC) segments, each RLC segment associated with a sequence number (SN); determine a reassembly timer expiration time for the one or more RLC segments based on the associated SNs and the reassembly timer configuration information; and release the one or more RLC segments prior to the reassembly timer expiration time based on an adjusted reassembly timer expiration time.

In yet another additional aspect, a device for wireless communication includes: at least one processor; and a memory coupled to the at least one processor. The at least one processor is configured to cause the device to: receive reassembly timer configuration information; receive one or more radio link control (RLC) segments, each RLC segment associated with a sequence number (SN); determine a reassembly timer expiration time for the one or more RLC segments based on the associated SNs and the reassembly timer configuration information; adjust the reassembly timer expiration time based on a determination by the device; and release the one or more RLC segments based on the adjusted reassembly timer expiration.

Accordingly, the UE 115 and network entity 405 may be able to more efficiently perform reassembly timer operations by leveraging UE based AI/ML techniques to dynamically adjust the reassembly timer. Using AI/ML learning model outputs to dynamically adjust the reassembly timer may enable efficiency improvements, such as power, memory, and/or bandwidth conservation and latency reduction. Performing enhanced reassembly timer operations thus improves the user experience and the network as a whole.

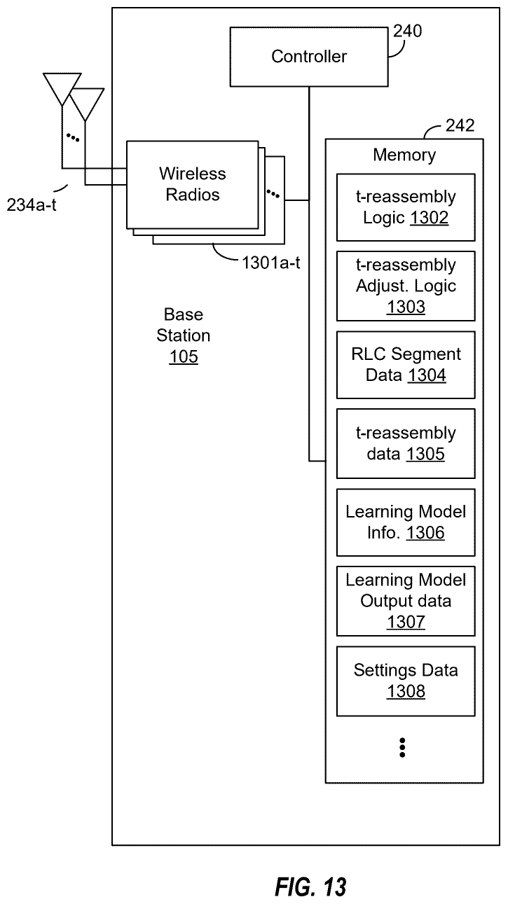

FIG. 11 is a flow diagram 1100 illustrating example blocks executed wireless communication device (e.g., a UE or network entity, such as a base station) configured according to an aspect of the present disclosure. The example blocks will also be described with respect to base station 105 as illustrated in FIG. 13. FIG. 13 is a block diagram illustrating base station 105 configured according to one aspect of the present disclosure. Base station 105 includes the structure, hardware, and components as illustrated for base station 105 of any of FIG. 2 or 4-7 or network entity 405 of FIG. 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1301a-t and antennas 234a-t. Wireless radios 1301a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 13, memory 242 stores one or more of reassembly timer logic 1302, reassembly timer adjustment logic 1303, RLC segment data 1304, reassembly timer data 1305, learning model information 1306, learning model output data 1307, and settings data 1308. The data (1302-1308) stored in the memory 242 may include or correspond to data and/or logic to enable the operations of FIGS. 4-7.

At block 1102, a wireless communication device, such as a base station or network entity, transmits reassembly timer configuration information. For example, the reassembly timer configuration information may include or correspond to one or more of the reassembly timer data 406, the reassembly timer adjustment data 408, the reassembly timer AI/ML model data 444, or the reassembly timer settings data 446 of FIG. 4. To illustrate, the network entity 405 (e.g., base station 105) transmits the reassembly timer settings data 446 in the configuration transmission 450 to the UE 115, as described with reference to FIG. 4.

At block 1104, the device transmits one or more radio link control (RLC) segments, each RLC segment associated with a sequence number (SN), wherein the one or more RLC segments are associated with a reassembly timer expiration time based on the reassembly timer configuration information. For example, the one or more RLC segments may include or correspond to any of the RLC segments of downlink transmissions described with reference to FIGS. 4-7, such as the first RLC SDUs 452 (e.g., any SDU segment or segments thereof) and/or the second RLC SDUs 454 (e.g., any SDU segment or segments thereof) of FIG. 4. The one or more RLC segments may also include or correspond to the RLC segment data 442 of FIG. 4, where they are associated with a SN or SNs and with a reassembly timer or a reassembly timer expiration value, such as in the reassembly timer data 406. To illustrate, the network entity 405 transmits the first RLC SDUs 452 and/or the second RLC SDUs 454 of FIG. 4 in downlink transmissions PDSCHs) to the UE 115, as described with reference to FIG. 4.

At block 1106, the device receives a reassembly timer update or stop indication associated with the one or more RLC segments prior to the reassembly timer expiration time. For example, the reassembly timer update or stop indication may include or correspond to the reassembly timer dynamic update transmission 456 of FIG. 4, the reassembly timer early termination indication of FIG. 5, the reassembly timer dynamic update indication of FIG. 6, or the reassembly timer dynamic update request of FIG. 7. To illustrate, the network entity 405 receives the reassembly timer dynamic update transmission 456 from the UE 115, as described with reference to FIG. 4. Receipt of the reassembly timer dynamic update transmission 456, may cause the network entity to terminate of the reassembly timer, transmit a response message (such as reassembly timer dynamic update transmission 456 or any of the responses of FIGS. 5-7), retransmit the RLC SDUs, etc., or a combination thereof.

The wireless communication device (e.g., such as a UE or base station) may execute additional blocks (or the wireless communication device may be configured further perform additional operations) in other implementations. For example, the wireless communication device may perform one or more operations as described with reference to FIGS. 4-7. As another example, the wireless communication device may perform one or more aspects as described above with reference to FIGS. 10 and 12 or one or more aspects as presented below.

Accordingly, the UE 115 and network entity 405 may be able to more efficiently perform reassembly timer operations by leveraging UE based AI/ML techniques to dynamically adjust the reassembly timer. Using AI/ML learning model outputs to dynamically adjust the reassembly timer may enable efficiency improvements, such as power, memory, and/or bandwidth conservation and latency reduction. Performing enhanced reassembly timer operations thus improves the user experience and the network as a whole.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 1-13 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
receive reassembly timer configuration information;
receive one or more radio link control (RLC) segments, each RLC segment associated with a sequence number (SN), wherein the one or more RLC segments are associated with a reassembly timer expiration time based on the reassembly timer configuration information; and
release, prior to the reassembly timer expiration time, the one or more RLC segments based on an adjusted reassembly timer expiration time, the adjusted reassembly timer expiration time determined based on an output from a learning model of the device.

2. The device of claim 1, wherein the at least one processor is further configured to cause the device to:
transmit a status report to network indicating early termination responsive to expiration of the adjusted reassembly timer expiration time.

3. The device of claim 2, wherein the status report includes an early termination flag bit.

4. The device of claim 3, wherein the status report further indicates an amount of time the reassembly timer expiration time was adjusted or an amount of time remaining on a reassembly timer for the one or more RLC segments when adjusted.

5. The device of claim 1, wherein the at least one processor is further configured to cause the device to:
transmit a reassembly timer stop polling bit indicating that the device has stopped the reassembly timer early, responsive to expiration of the adjusted reassembly timer expiration time.

6. The device of claim 1, wherein the reassembly timer configuration information indicates a network configured reassembly timer duration and whether artificial intelligence (AI) or machine learning (ML) behavior is permitted for reassembly timer adjustment operations.

7. The device of claim 1, wherein the reassembly timer configuration information indicates a minimum reassembly timer duration, a maximum reassembly timer duration, a reassembly timer stop prohibit interval value, a reassembly timer prediction error backoff value, a reassembly timer performance target metric, or a combination thereof, and wherein the reassembly timer performance target metric includes an underprediction metric, an overprediction metric, an end-to-end (E2E) latency metric, a retransmission metric, or a combination thereof.

8. The device of claim 1, wherein the at least one processor is further configured to cause the device to:
determine, using the learning model, a probability distribution value indicating when a particular SN of the SNs of the one or more RLC segments will be completely received and a likelihood of whether the particular SN will not be received before expiration of a reassembly timer for the one or more RLC segments.

9. The device of claim 8, wherein the at least one processor is further configured to cause the device to:
determine, using the learning model, an expected latency of the particular RLC segment and whether a latency for the particular RLC segment will extend beyond expiration of the reassembly timer, a packet delay budget threshold, or both.

10. The device of claim 9, wherein the at least one processor is further configured to cause the device to:
determine whether the probability distribution value satisfies a probability distribution value threshold;
determine, based on a determination that the probability distribution value satisfies the probability distribution value threshold, whether the expected latency of the particular RLC segment will extend beyond the expiration of the reassembly timer expiration time; and
determine to adjust the reassembly timer expiration time based on a determination that the expected latency of the particular RLC segment will extend beyond the expiration of the reassembly timer.

11. The device of claim 9, wherein the at least one processor is further configured to cause the device to:
determine the adjusted reassembly timer expiration time based on the expected latency of the particular RLC segment and the probability distribution value; and
adjust the reassembly timer expiration time to the adjusted reassembly timer expiration time based on a comparison of a performance metric of the learning model to an underprediction metric, an overprediction metric, or both, wherein the overprediction metric is determined based on a duplicated transmission metric.

12. The device of claim 9, wherein the at least one processor is further configured to cause the device to:
determine to not adjust the reassembly timer expiration time based on:
a determination that the probability distribution value does not satisfy the probability distribution value threshold; or
a determination that the expected latency of the particular RLC segment will not extend beyond the expiration of the reassembly timer.

13. The device of claim 1, wherein the at least one processor is further configured to cause the device to:
determine the reassembly timer expiration time for the one or more RLC segments based on the associated SNs and the reassembly timer configuration information; and
adjust the reassembly timer expiration time to the adjusted reassembly timer expiration time based on a determination by the learning model of the device.

14. The device of claim 13, wherein the processor configured to cause the device to determine the reassembly timer expiration time for the one or more RLC segments based on the associated SNs and the reassembly timer configuration information includes to:
start a reassembly timer for a particular RLC segment of the one or more RLC segments responsive to detection of a missed RLC segment of the one or more RLC segments based on the associated SNs of the one or more RLC segments and the reassembly timer configuration information, the reassembly timer set based on a reassembly timer expiration duration indicated in the reassembly timer configuration information.

15. The device of claim 14, wherein the at least one processor is further configured to cause the device to:
detect the missed RLC segment, wherein to detect the RLC segment includes to:
determine the SN for each RLC segment of the one or more RLC segments;
determine a particular sequence based on the determined SNs; and
determine a gap in the particular sequence for the received one or more RLC segments indicating a not yet received RLC segment.

16. The device of claim 13, wherein the at least one processor configured to cause the device to adjust the reassembly timer expiration time includes to:
determine the adjusted reassembly timer expiration time for the one or more RLC segments using the learning model and one or more inputs, wherein the one or more inputs include an amount of retransmissions, an amount of physical resource blocks (PRBs), a multiple-input/multiple-output (MIMO) configuration, modulation coding scheme (MCS) information, physical (PHY) layer parameter information, a transport block size, channel quality information, or a hybrid automatic repeat request (HARQ) round-trip time (RTT).

17. The device of claim 13, wherein the at least one processor configured to cause the device to adjust the reassembly timer expiration time includes to:
determine the adjusted reassembly timer expiration time for the one or more RLC segments using the learning model, one or more inputs, and one or more constraints, wherein the one or more constraints include a network configured maximum reassembly timer duration, a network configured minimum reassembly timer duration, a network configured maximum reassembly timer adjustment value, a network configured minimum reassembly timer adjustment value, a fallback reassembly timer value, or fallback behavior information.

18. The device of claim 13, wherein the at least one processor configured to cause the device to adjust the reassembly timer expiration time includes to:
determine to adjust the reassembly timer expiration time for the one or more RLC segments based on the learning model;
transmit a reassembly timer update request to a network device, the reassembly timer update request includes one or more recommended reassembly timer parameter values, reassembly timer learning model prediction information, or both; and
receive, responsive to the reassembly timer update request, a reassembly timer update response from the network device indicating the adjusted reassembly timer expiration time.

19. The device of claim 1, wherein the at least one processor is further configured to cause the device to:
transmit, based on the adjusted reassembly timer expiration time, a hybrid automatic repeat request (HARQ) feedback transmission indicating feedback information for the one or more RLC segments; and
receive one or more retransmissions for the one or more RLC segments based on the HARQ feedback transmission.

20. The device of claim 1, wherein the at least one processor is further configured to cause the device to:
store actual RLC latency data, estimated latency data of RLC segments, estimated reassembly timer values, learning model input data, learning model performance data, or a combination thereof, in as reassembly timer log data; and
transmit the reassembly timer log data to the network or to a learning model server.
